(19) United States
(12) Patent Application Publication
(10) Pub. No.: US 2020/0201262 A1
(43) Pub. Date: Jun. 25, 2020

(54) Timer devices

(71) Applicant: Senver Holdings Pty Ltd, Sutherland (AU)

(72) Inventors: Gary Martin Verdickt, Sutherland (AU); Stuart Richard May, Sutherland (AU); Hugo Blanc, Sutherland (AU)

(21) Appl. No.: 16/807,685

(22) Filed: Mar. 3, 2020

Related U.S. Application Data
(63) Continuation-in-part of application No. PCT/AU2018/050998, filed on Sep. 13, 2018.

(30) Foreign Application Priority Data
Sep. 15, 2017 (AU) 2017903757
Oct. 12, 2017 (AU) 2017904128
Jan. 5, 2018 (AU) 2018900030

(51) Int. Cl. G04F 1/00; G09F 3/00

(52) U.S. Cl. CPC G04F 1/005; G09F 2003/0269; G09F 3/0292

(57) ABSTRACT

The present disclosure describes timer devices that include a timer to monitor a time period and a signalling apparatus that provides an alert signal on expiry of the time period. In some embodiments, a label assembly is provided including first and second labels releasably connected to each other, each label each including a timer and signalling apparatus, In some embodiments, a label is provided with first, second and third portions, the first and second portions including respective fixing portions and the third portion including a timer and signalling apparatus. In some embodiments a timer assembly is provided where movement of a timer unit to a second position initiates monitoring of a predetermined time period, in some embodiments, a label assembly is provided that includes a timer and signalling apparatus and an elongate portion that forms a closed loop by extending into a through hole of the label assembly, in some embodiments, a label that includes a timer and signalling apparatus is provided in the form of a wristband. In some embodiments, a label that includes a timer and signalling apparatus is provided that includes a transparent or translucent fixing portion.

The present application is a continuation-in-part of PCT Application no. PCT/AU2018/050998 entitled “Timer Devices”, filed 13 Sep. 2018, and claims the benefit of, and incorporates by cross-reference, the entire contents of PCT Application no. PCT/AU2018/050998, Australian Provisional Patent Application No. 2017903757 entitled “Timer label assembly”, filed 15 Sep. 2017, Australian Provisional Patent Application No. 2017904128 entitled “Timer assembly”, filed 12 Oct. 2017, and Australian Provisional Patent Application No. 2018900030 entitled “Timer label assemblies and timer labels”, filed 5 Jan. 2018.

### TECHNICAL FIELD

The present disclosure pertains to monitoring of a time period relating to an item, including during use or transport of the item, or relating to an activity. Examples of items include medical products such as a medical devices including intravenous catheters, urinary catheters, intravenous tubing sets or wound dressings, or pharmaceuticals, cargo, biological matter, chemicals or otherwise.

### BACKGROUND

It can be desirable to monitor time periods related to items and/or activities.

For example, it can be desirable to monitor time periods relating to transported items. It is common to transport items between a variety of geographical locations, including domestically and internationally and using parcel delivery and freight infrastructure.

Transported items can include hazardous materials, biological materials and/or perishable foods, for which the transportation can be time critical. Should the item not be delivered or used within a specific time frame, the item may be spoiled or may fall foul of regulations designed to govern safe or effective use of the item.

It can also be desirable to monitor time periods relating to items and/or activities including, for example, in the medical space.

In the medial space, despite stringent hospital guidelines for controlling the spread of bacteria, hospital-acquired infections, also known as healthcare-associated infections or “HAIs”, are commonplace. HAIs result in unnecessary suffering for patients, extended healthcare and hospital times and significant costs to healthcare systems. A significant proportion of HAIs are caused through use of indwelling medical devices that are inserted in patients for longer than a safe time period. For example, an intravenous cannula can be inserted in a patient's vein to deliver fluids, drugs or medical instruments. However, the intravenous cannula can also act as a conduit for bacteria to enter the human body and can provide a protected environment for bacterial incubation, leading to HAIs. With approximately 1.5 billion cannulae implanted in patients globally each year, reducing the number of HAIs caused by cannulae and other medical devices, such as urethral catheters, is paramount.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

One or more aspects of the present disclosure may relate to a timer device, such as a label assembly, a label or a timer assembly.

A timer device may be configured to monitor a predetermined time period, such as a time period related to transport of an item. For example, a timer device may be a shipping label assembly configured to monitor a predetermined time period related to an item that is shipped from a dispatch location. The item may be, for example, a hazardous material, a biological material or a perishable food item, which must be delivered prior to expiry of the predetermined time period, removed from it packaging and stored in a more suitable environment prior to expiry of the predetermined timer period, and/or used before expiry of the predetermined time period. Failure to meet any of these time-critical requirements may result in spoiling of the item and/or may cause the item to fall foul of regulations designed to govern safe or effective use of the item. For example, the item that is shipped may be a biological material such as a tissue graft that must be surgically implanted in a patient before expiry of the predetermined time period, e.g. 48 hours, 72 hours or 108 hours, etc., and thus before expiry of the graft.

A timer device may alternatively or additionally be configured to monitor a predetermined time period relating to a variety of products and/or activities.

For example, the timer device may be configured to monitor a predetermined time period associated with a medical device such as an intravascular cannula that is to be inserted in a patient for a period of time. A cannula is an example of an invasive medical device that should be located in a patient for no longer than a maximum safe period (e.g., 24 hours, 48 hours, 72 hours, 7 days or otherwise), as governed by medical standards, protocols or regulations applicable to the environment where it is used (e.g., hospital, ambulance or clinic, etc.), or manufacturer's guidelines for the medical device. By limiting indwelling of a medical device such as a cannula to a maximum safe timer period or less, based on monitoring of that time period using the timer assembly, the risk of the patient contracting a HAI can be significantly reduced. In another example, a timer device may be configured to monitor a predetermined time period relating to an endoscope that is sterilized and that must be used within a specific period after sterilization to reduce the risk of causing an infection. In alternative embodiments, a timer device may be used with any medical device for which monitoring of a predetermined time period is desirable, such as a compression bandage or a drug delivery patch, or a hospital bed.

In yet another example, a tinier device may be configured to monitor a predetermined time period associated with maintenance or calibration of an item. One or more of emergency kits or carts, sterile packages, cassettes, patient-controlled analgesia pumps, infusions pumps or hospital beds may require periodic calibration, maintenance or replacement to ensure that they are in proper working order. The timer device in this example may be coupled to the item to be monitored to provide an indication to a user when maintenance may be required or should be considered.

The timer device may comprise at least one actuator to initiate the monitoring of the predetermined time period.

In some aspects of the present disclosure, a timer device may comprise a plurality of timer portions (e.g. labels), configured to be separable from each other. Each of the timer portions may be further configured to monitor the same predetermined time period as each other at the same time. Each of the timer portions may comprise a signalling apparatus that provides an alert signal on expiry of the predetermined time period. At least one of the timer portions may comprise a fixing portion as will be described in further detail elsewhere in the present disclosure.

One or more of the plurality of timer portions may comprise a frangible element, tear line, tear notch, perforations and/or other region of weakness that enables manual separation. In one form, the timer portions may be releasably connected to each other to enable manual separation of the timer portions.

The timer device may be a shipping label assembly comprising a first timer portion and a second timer portion (e.g. in the form of a first label and a second label, respectively). The predetermined time period that is monitored by the first and second portions may be a time period relating to an item that is shipped. The predetermined time period may correspond to a time period by which the item must be delivered from a dispatch location to its intended destination and/or by which an action must be taken subsequent to arrival at its intended destination.

The provision of a plurality of timer portions (e.g. first and second labels) may allow one of the timer portions, e.g. the first label, to be retained by a party at the dispatch location and the other of the tinier portions, e.g. the second label, to be sent with the item that is dispatched. This may allow multiple parties to conveniently monitor the predetermined time period, including both the party dispatching the item and the recipient of the item, for example. Additionally or alternatively, it may allow other parties, e.g. intermediaries such as shipping contractors involved in the shipping process, to monitor the predetermined time period during shipping to its intended destination.

At the dispatch location, the first timer portion (e.g. first label) may be fixed, using the fixing portion when present, to an item to remain at the dispatch location. The fixing portion may be fixed to an item such as a wall, notice board, whiteboard or other surface in such a way that a relevant person may be readily alerted at least to the expiry of the predetermined time period by the alert signal from the signalling apparatus of the first label. in the lead up to expiry of the predetermined time period and/or upon expiry of the predetermined time period, that person may elect to perform a check in relation to the shipped item. For example, they may check records or even contact the intended recipient and/or shipping contractor to determine if the item has been received in suitable time, to determine it the item is due to be received in time and/or to determine if a necessary action has been taken in relation to the received item.

Meanwhile, the second timer portion (e.g. second label) may be maintained with the item that is shipped. For example, the second timer portion may be fixed directly to a surface of a shipping crate or parcel that contains the item or may be located in a label pouch that is fixed to the shipping crate or parcel. In the lead up to expiry of the predetermined time period and/or upon expiry of the predetermined time period, a shipping contractor or recipient of the item may be alerted to the imminent expiry or actual expiry of the predetermined time period and take any appropriate action.

The configuration of the timer device, comprising the plurality of timer portions (e.g. the first and second labels) that can monitor a common time period, e.g. upon simultaneous initiation, while being separable and independently locatable, may be particularly advantageous when the predetermined time period is to be monitored in more than one time zone, e.g. during a shipping process. It can avoid complications that might otherwise occur as a result of incorrect calculation of time across different time zones. Moreover, the use of a plurality of timer portions (e.g. first and second labels), which provide physical items that are specifically constructed for the purpose of co-monitoring of a predetermined time periods, may provide suitable alerts to any person involved in the shipping process, whether or not their involvement is pre-arranged or extemporaneous. This can contrast with any monitoring system that might rely on computer alerts, where access to a computer and/or authorisation to access suitable computer software may be required but not always available.

While certain example uses of the timer device comprising the plurality of timer portions are described above, the plurality of timer portions may be used for a variety of different purposes where a common predetermined time period is to be monitored at different locations, including at different locations within the same room, laboratory, building or facility.

Following from the above, according to an aspect of the present disclosure, a label assembly is provided comprising at least first and second labels, wherein:
the first label comprises:
   a first timer to monitor a predetermined time period; and
   a first signalling apparatus that provides an alert signal on expiry of the predetermined time period; and
the second label comprises:
   a second timer to monitor the predetermined time period; and
   a second signalling apparatus that provides an alert signal on expiry of the predetermined time period;

the first and second labels are releasably connected to each other; and
the first and second timers are configured to monitor the predetermined time period at the same time.

In one embodiment, the label assembly comprises a first actuator to initiate monitoring of the predetermined time period by the first timer and a second actuator to initiate monitoring of the predetermined time by the second timer. A user may operate both actuators simultaneously or may operate the actuators in quick succession in order to initiate monitoring of the predetermined time period by both the first and second timers at the same time.

In another embodiment, the label assembly comprises a common actuator is configured to simultaneously initiate monitoring of the predetermined time period by both the first and second timers. By using a common actuator, the label assembly may configured so that monitoring of the predetermined time period by the first and second timers must take place at the same time. The common actuator may be configured to prevent initiating of the monitoring of the predetermined time period by the first tinier without initiating monitoring of the predetermined time period by the second timer, and vice-versa.

In any aspects disclosed herein, an actuator may be any suitable element operable by a user to cause initiation of the monitoring of the predetermined time period. For example, the actuator may comprise a button or a slider that is pressed or slid by a user to initiate the monitoring, or may comprise at least one tab or release element that is released (e.g. pulled and/or otherwise removed) to initiate the monitoring. Additionally or alternatively, the actuator may comprise a magnetic switch that is operable by moving the timer relative to or into a magnetic field. The switch may be a proximity switch such as a magnetic switch, e.g., a reed switch.

In some embodiments, a seal may be configured to cover and/or close (e.g. to seal) any opening which may otherwise be created upon movement or removal of an actuator. The seal may comprise a gasket, such as a set of gasket elements located on or around the actuator to seal the opening. The set of gasket elements may comprise neoprene foam or other material suitable for expanding into and/or across the opening to seal the opening. The gasket elements may be resiliently biased towards a position in which they seal the opening, such that they provide a sealing mechanism that automatically seals the space that was previously occupied by the actuator, upon removal of the actuator.

Related to this, in one aspect of the present disclosure there is provided a timer device comprising:
a timer to monitor a time period, the timer including a signalling apparatus that provides an alert signal on expiry of the time period, the timer including an actuator that is removable, through an opening, to initiate monitoring of the time period; and
a sealing mechanism to seal the opening after removal of the actuator.

In some embodiments, one or both of the first and second labels comprises a releasable backing layer configured such that release of the backing layer(s) initiates monitoring of the time period by at least one of the first and second timers. For example, the releasable backing layer can be connected to at least one actuator tab such that removal of the backing layer releases the tab to initiate the monitoring.

In some embodiments, the monitoring of the predetermined time period by the first and/or second timer may be initiated by disconnecting a releasable connection between the first label and the second label. For example, at least one of the actuators may comprise a tab that extends across the connection between the first and second labels, the tab being released to initiate the monitoring as a direct result of separating the first and second labels.

In general, one or more of the actuators may comprise at least one tab. The at least one tab may include an end or region, e.g. a distal end or region, that is engageable by a user's fingers to release the tab to initiate the monitoring.

When the actuator comprises at least one tab, at least part of the tab, e.g. a proximal end or region of the tab, may be interposed between electrical components of the respective label to prevent current flow to the electrical components. The electrical components may include the timer and a power source and the part of the tab may be interposed between the timer and the power source. Upon removal of the tab, electricity may begin to flow to the timer, causing initiation of the monitoring of the predetermined time period.

A common actuator may comprise a tab that branches, e.g. bifurcates, to contact electrical components associated with the first timer and to contact electrical components associated with the second timer. The tab may have a first proximal end that is disposed between electrical components of the first label and a second proximal end that is disposed between electrical components of the second label. The tab may comprise a bridge section that extends between the first and second proximal ends. A user may engage the bridge section to effect removal of the tab to initiate the monitoring. Additionally or alternatively, the tab may comprise a third, distal end that is engageable by the user to effect removal of the tab to initiate monitoring. The third end may extend from the bridge section, for example.

In general, references herein to monitoring of the predetermined time period “at the same time” should not exclude there being a slight delay between initiation of monitoring of the predetermined time period between the first and second timers, if the delay is insignificant relative to the length of the predetermined time period that is being monitored. For example, the delay may be in the order of a fraction of a second or a few seconds, whereas the predetermined time period that is monitored may be in the order of multiple hours or days.

The predetermined time period that is monitored may be 12 hours, 24 hours, 36 hours, 48 hours, 72 hours, 96 hours or 108 hours in some examples, or any other time period that it is useful to monitor including times measured in days, months or years.

In some forms, the timer device may be configured to vary a predetermined time that the device is to monitor. In other forms, the timer device may be programmed with a predetermined time which is not able to be varied. In such a configuration, the user may advantageously be able to simply commence monitoring of the predetermined time, aware that the timer device is monitoring for the appropriate length of time, which may improve usability of the timer device.

In some embodiments, the label assembly consists of two labels, i.e. only the first label and the second label, and not any additional labels.

In one embodiment, the first and second labels are located side by side and the connection between the first and second labels extends between adjacent side edges of the first and second labels. In another embodiment, the first and second labels are in a stacked configuration, one on top of other (e.g., with the first and second labels being located back-to-back, front-to-front, front-to-back or back-to-front). In this arrangement, the connection between the first and second labels may extend along a fold of the label assembly between the first and second labels.

In any aspects disclosed herein, a timer device may be configured to be coupled to another object or item, such as an item in relation to which a time period is to be monitored, by securement, mounting or a number of other mechanisms. In a label assembly, at least one of the first or second labels may comprise a fixing portion to fix the label to a support surface. The support surface may not be a part of the label assembly. The fixing portion may comprise adhesive, e.g., an adhesive layer, to fix the label to the support surface. The fixing portion may comprise a backing layer that is releasable to expose the adhesive and place the label in a state for fixing to the support surface. As indicated above, in some embodiments release of the backing layer may perform a function in the initiation of monitoring of the predetermined time period.

Other types of fixing portions may be provided, however, e.g., depending on the nature of a support surface to which the label is to be fixed. For example, the fixing portions may comprise a hook/loop fastener, a magnet, a clip, a silicone or elasticized loop, or otherwise.

A fixing portion in one form may comprise a through-hole, for example configured to receive a mounting portion, as will be described in further detail elsewhere in the present disclosure.

In some embodiments, the first label may comprise the fixing portion to fix the label to a support surface and the second label may be absent of any fixing portion to fix the label to a support surface. When any one of the first and second labels does not have a fixing portion, the label may be designed to be located in a label pouch and/or designed to be used with an external fixation mechanism such as a hook, clip or otherwise. Nevertheless, a user may opt to locate the label in a pouch or use the label with an external fixation mechanism, even when that label comprises its own fixing portion.

In any aspects disclosed herein, one or each label may comprise a power source such as a battery to power a timer and a signalling apparatus of the label. The power source, signalling apparatus and timer of the label may be comprised in an electronics unit. An electronics unit may be located in a housing, which may protect components of the electronic unit from damage.

A signalling apparatus may comprise one or more signalling elements that produce the alert signal. Signalling elements may comprise any one or more of a display, a loudspeaker, a vibration means, and a light, for example. The alert signal may comprise any one or more of an audible signal, a visual signal and a tactile signal, tier example. The display may comprise any one or more of an LCD display, LED display, plasma display and E-ink display, for example. The light may comprise an LED or light bulb, for example.

When a display is provided, the display may provide an indication of the degree to which the predetermined time period has elapsed following commencement of monitoring of the predetermined time period (e.g., a countdown of time, a count up of time or other visual indicator). Where the display is used to provide an alert signal upon expiry of the predetermined time period, the display may flash or provide some other readily identifiable warning signal.

When a loudspeaker is provided, the loudspeaker may issue an alert signal by sounding, e.g., by beeping loudly.

When a light is provided, the light may issue an alert signal by turning on, turning off, flashing on and off, and/or by changing colour.

In addition to providing an alert signal on expiry of the predetermined time period, the signalling apparatus may provide one or more alert signals in the lead up to, or before, expiry of the predetermined time period e.g. to indicate that the predetermined time period is being monitored and the time period has not yet expired. The alert signals may be different for different portions of time in the lead up to expiry of the predetermined time period. For example, a first type of alert signal may be issued prior to expiry of the predetermined time period and a second type of alert signal may be issued on expiry of the predetermined time period. As another example, a first type of alert signal may be issued during a first time portion following initiation of monitoring of the predetermined time period, a second type of alert signal may be issued during a second time portion that follows the first time portion and is prior to expiry of the predetermined time period, and a third type of alert signal may be issued upon expiry of the predetermined time period. In the later example, the first type of alert signal may indicate that there remains significant time until expiry of the predetermined time period, the second type of alert signal may indicate that expiry of the predetermined time is relatively soon or imminent, and the third alert signal may indicate that the predetermined time period has expired. The alert signals may be light signals that are different colours or different combinations of colours. The signalling apparatus may comprise at least one LED to provide the alert signal.

Any alert signal may be continually emitted, periodically emitted, or emitted only upon an actuation step being carried out by the user. The actuation step may comprise pressing of a button comprised in the label, for example The actuation step may therefore enable a user to interrogate the status of the label, e.g., to check if the label is still monitoring the time period and/or to check if the predetermined time period has expired. The use of the actuation step may provide an energy saving measure. However, it may be preferred to exclude an actuation step to interrogate the status of the label to ensure that an alert signal is easily seen, heard and/or felt at all times.

In one embodiment, the signalling apparatus comprises one or more signalling elements that produce the alert signal, such as one or more lights that emit differently coloured light. In one example, where first and second types of alert signals are used, the first type of alert signal may include a first colour light, e.g., green light, and the second type of alert signal may include a second colour light, e.g., red light. In another example, where first, second and third alert signals are used, the first type of alert signal may include first colour light, e.g., green light, the second type of alert signal may include a second colour light, e.g. yellow light, or a combination of coloured light, e.g. alternating green and red light, and the third type of alert signal may include a third colour of light, e.g. red light. The alert signal may be emitted continuously or in a flashing, beeping or repeating pattern.

A timer device may be a single-use timer device that is inoperable to monitor a time period after providing the alert signal. Alternatively, the timer device may be capable of being reset, enabling multiple uses.

It will be understood that the above descriptions of potential arrangements of the display, loudspeaker, light, alert signal or signalling apparatus of a label assembly may be similarly applicable for any timer device, including a label assembly, a label or a timer assembly, as described herein.

One or both of the first and second labels may comprise first and second portions that are releasably connected to each other. The label may be divisible into the first and second portions by releasing a connection between the first and second portions. The first portion may be located towards a first end of the label and the second portion may be located towards a second end of the label, opposite from the first end, along a longitudinal axis of the label.

The first portion may be manually separable from the second portion. The connection between the first and second portions may comprise a frangible element, tear line, tear notch, perforations and/or other region of weakness that enables manual separation of the first and second portions. Thus, the first portion may be torn from the second portion, for example. In addition to or as an alternative to tearing, the first and second potions may be snapped apart, cut apart or otherwise. Cutting may involve use of scissors or other types of cutting elements.

At least the signalling apparatus may be comprised in the first portion of the label and at least the fixing portion may be comprised in the second portion of the label. In some embodiments, in addition to the signalling apparatus, the first portion further comprises the timer and the power source. Indeed, in some embodiments, all electrical components of the label may be comprised in the first portion.

By providing a first portion that comprises the electrical components and a second portion that comprises the fixing portion, the first and second portions of the label may take substantially different forms. For example, the second portion may be maintained as a relatively flexible, fiat and/or discreet portion of the label that can be fixed to a number of different support surfaces, including contoured surfaces, while the first portion may be maintained as a relatively inflexible and/or bulky portion suitable for housing the electronics. Moreover, provision of first and second portions that are separable can allow the first portion to be removed or disconnected from a support surface to which the label is fixed (e.g. a notice board, paper records, a container or otherwise) while the second portion remains fixed to that support surface. Electrical components of the label such as the signalling apparatus may be relatively bulky. Accordingly, by locating electrical components in the first portion and permitting removal of the first portion from the second portion, e.g., after the predetermined time period has expired and the alert signal has been made, the second portion only may remain permanently attached to the support surface. The second portion may be relatively small and/or streamlined in comparison to the first portion. In addition to providing for a reduction in size of the label, removal of the first portion may provide a visual indication that the monitoring of the predetermined time period has expired and any necessary action has been taken as a result of its expiry. Moreover, when the signalling apparatus or other electronic elements are located in the first portion, providing the option of removing the first portion from the second portion fixed to a support surface can assist with waste disposal or recycling practices. It can allow the electrical components of the first portion to be disposed of using appropriate e-waste or e-recycling techniques, for example.

By optionally maintaining fixation of the second portion to a support surface, the second portion may provide a record in relation to the monitoring of the predetermined time period that remains part of the support surface, e.g. part of paper records, the notice board, the surface of a container or otherwise.

Timer devices as disclosed herein may comprise a display portion to provide information relating to the item relating to the monitored predetermined time period. The display portion may comprise a surface on which a user can write information and/or a surface on which information is pre-printed. The information may include, for example, any one or more of: the time and date of dispatch, the name of the sender, the name of the intended recipient, an indication of whether the item was received in time, the time of receipt, the date of receipt, and a signature. Where the timer device includes first and second portions as described above, the second portion may comprise the display portion, although another portion of a timer device may additionally or alternatively comprise a display portion.

As indicated above, the first and second labels are releasably connected to each other. Moreover, at least one of the first and second labels can have first and second portions that are also releasably connected to each other. In some examples, a releasable connection may comprise a visual cue, such as a line, indicating where the connection between the first and the second labels and/or the first and the second portions may be released without disturbing a timer. In normal use of the label assembly and components thereof, it is expected that the first and second labels will be separated from each other prior to any separation of first and second portions of any of the labels. However, there is a risk that an action to separate the first and second labels could, simultaneously, cause separation of the first and second portions. The label assembly may include features to mitigate this risk. For example, in the label assembly, the releasable connection between the first and second portions may be stronger than the releasable connection between the first and second labels.

As discussed above, the connection between the first and second labels may comprise perforations and the connection between the first and second portions may also comprise perforations. So that the releasable connection between the first and second portions is stronger than the releasable connection between the first and second labels, the perforations between the first and second portions may be less frequent and/or smaller than the perforations between the first and second labels.

According to another aspect of the present disclosure, a label is provided comprising:
a first label portion, a second label portion and a third label portion, the third label portion being connected to, and located between, the first and second label portions;
wherein the third label portion comprises a timer to monitor a predetermined time period and a signalling apparatus that provides an alert signal on expiry of the predetermined time period; and
wherein the first label portion comprises a first fixing portion to fix the label to a support surface and the second label portion comprises a second fixing portion to fix the label to the support surface.

In some embodiments, the third label portion may not comprise any fixing portion to fix the label to the support surface.

In some embodiments, the first and second fixing portions may be discrete portions and, in other embodiments, the first and second fixing portions may be conjoined. In some embodiments, the first and second fixing portions may form parts of a fixing means that surrounds the third label portion.

Each fixing portion may comprise adhesive, e.g., an adhesive layer, to fix the label to a support surface. Each fixing portion may comprise a backing layer that is releasable to expose the adhesive and place the label in a state for fixing to the support surface. Other types of fixing portions may be provided, however, e.g., depending on the nature of a support surface to which the label is to be fixed. For example, the fixing portions may comprise a hook/loop fastener, a magnet, a clip or otherwise.

The first label portion may be located towards a first end of the label and the second label portion may be located towards a second end of the label, opposite from the first end, e.g., along an axis such as a longitudinal axis of the label, the third label portion being located between the first and second label portions along the axis.

In general, the label may be configured so that the first and second fixing portions can fix the label to the support surface in a secure manner, the fixing occurring at least at a plurality of (e.g. opposite) sides of the third label portion where the timer is provided. This may contrast with, for example, a label configuration in which a fixing portion is provided to one side only of a region comprising the timer and signalling apparatus, in which case the label may be at greater risk to being unintentionally released from the support surface, e.g. by a loose end of the label getting caught and/or pulled by mistake.

The third label portion may comprise a power source such as a battery to power the timer and the signalling apparatus. The power source, the signalling apparatus and the timer may be comprised in an electronics unit. The electronics unit may be located in a housing, which may protect the electrical components from damage. In some embodiments, all electrical components of the label may be comprised in the third label portion. The signalling apparatus may be arranged in accordance with signalling apparatus described above.

In some embodiments, initiating of monitoring of the predetermined time period can be carried out while the label is fixed to the support surface. When the label is fixed to a support surface, the electronics unit may be situated at a rear of the label so that the electronics unit and/or the housing comprising the electronics unit faces or rests against the support surface. So that any tab connected to the electronics unit is accessible to a user, a distal end of tab may extend through an opening at a front of the label. The opening may be provided in the third label portion or in one of the first and second label portions, for example.

In alternative embodiments, when a releasable backing layer is provided in one or both of the fixing portions, release of the backing layer may initiate monitoring of the time period by the timer. For example, the releasable backing layer can be connected to at least one actuator tab such that removal of the backing layer releases the tab to initiate the monitoring.

In some embodiments, the third label portion is releasably connected to the first and second label portions. The releasable connection between each of the label portions may comprise a frangible element, tear line, tear notch, perforations and/or other region of weakness that enables manual separation of the label portions. Thus, the third label portion may be torn from the first and second label portions, for example. In addition to or as an alternative to tearing, the first and second label portions may be snapped apart, cut apart or otherwise. Cutting may involve use of scissors or other types of cutting elements. Where a line of weakness is provided, e.g. a line of perforations, the line may extend in a direction that is perpendicular to the longitudinal axis of the label.

The arrangement of releasably connected label portions may be such that, while the first and second fixing portions fix the label to the support surface, the third label portion, including the timer and other electronics, can be removed from the label and the support surface. The first and second label portions may remain fixed to the support surface while the third label portion is removed.

By providing a third label portion that comprises the electrical components and first and second label portions that comprise fixing portions, the first and second label portions may take substantially different forms from the third label portion. For example, the first and second label portions may be maintained as relatively flexible, flat and/or discreet portions of the label that can be fixed to a number of different support surfaces, including contoured surfaces, while the third label portion may be maintained as a relatively inflexible and/or bulky portion suitable for robustly housing the electronics. Moreover, provision of first, second and third label portions that are releasable connected and therefore separable from each other can allow the third label portion to be removed or disconnected from a support surface to which the label is fixed (e.g. a notice board, paper records, a container or otherwise) while the first and second label portions remain fixed to that support surface. Electrical components of the label such as the signalling apparatus may be relatively bulky. Accordingly, by locating electrical components in the third label portion and permitting removal of the third label portion from the first and second label portions, e.g., after the predetermined time period has expired and the alert signal has been made, the first and second label portions only may remain permanently attached to the support surface. The first and second label portions may be relatively small and/or streamlined in comparison to the third label portion. In addition to providing for a reduction in size of the label, removal of the third label portion may provide a visual indication that the monitoring of the predetermined time period has expired and any necessary action has been taken as a result of its expiry. Moreover, when the signalling apparatus or other electronic elements are located in the third label portion, providing the option of removing the third label portion from the first and second label portions can assist with waste disposal or recycling practices. It can allow the electrical components of the third label portion to be disposed of using appropriate e-waste or e-recycling techniques, for example.

By optionally maintaining fixation of the first and second label portions to a support surface, at least one of the first or second label portions may provide a record in relation to the monitoring of the predetermined time period that remains part of the support surface, e.g. part of paper records, the notice board, the surface of a container or otherwise. For example, the first label portion may comprise a display portion to provide information relating to an item relating to which the predetermined time period is monitored. The display portion may comprise a surface on which a user can write information and/or a surface on which information is pre-printed. When the label is used in relation to a transported item, the information may include, for example, any one or more of: the time and date of dispatch, the name of the sender, the name of the intended recipient, an indication of whether the item was received in time, the time of receipt, the date of receipt, and a signature.

The label may be an independent label or may be comprised in a label assembly as described in relation to preceding aspects. For example, the first and/or second label of the label assembly may be a label comprising first, second and third label portions, along with first and second fixing portions, as described herein.

In some embodiments, the fixing portions may or may not be fixed directly to a separate support surface, but may extend at least partially around the support surface or article having the support surface, and fix to each other. In this regard, the label may form a closed loop for fixing the label to the support surface or article.

Related to this, according to one aspect of the present disclosure, a label is provided comprising:
a first label portion, a second label portion and a third label portion, the third label portion being connected to, and located between, the first and second label portions;
wherein the third label portion comprises a timer to monitor a predetermined time period and a signalling apparatus that provides an alert signal on expiry of the predetermined time period; and
wherein the first and second fixing portions are configured to be fixed together so that the label forms a closed loop.

The first and second label portions may be configured to be permanently fixed together so that release of the closed loop cannot be performed without permanently damaging the label. One or both of the first and second fixing portions may comprise a fixing element to fix the first and second label portions together. The fixing element may be an adhesive layer, for example.

The label may be configured to take the form of a band or other generally ring-shaped item that can extend around a support surface or article. While the article may be a product such as a medical device, container or otherwise, in some embodiments, it may be a body part such as a wrist. In this regard the label may be a wearable device such as a wristband, leg band or similar.

In some embodiments, the third label portion is releasably connected to one or both of the first label portion and the second label portion. The releasable connection between the label portions may comprise a frangible element, tear line, tear notch, perforations and/or other region of weakness that enables manual separation of the label portions. Thus, the third label portion may be torn from the first and/or second label portions, for example. In addition to or as an alternative to tearing, the first and second label portions may be snapped apart, cut apart or otherwise. Cutting may involve use of scissors or other types of cutting elements. Where a line of weakness is provided, e.g. a line of perforations, the line may extend in a direction that is perpendicular to a longitudinal axis of the label.

The releasable connection between the third label portion and the first and/or second label portions may allow the closed loop to be opened without requiring release of the first label portion from the second label portion. The release of the connection may enable dismounting of the label from the support surface or article (e.g. from the wrist or otherwise) The release of the connection may be irreversible. For example, release by tearing of perforations or otherwise may permanently damage the label, preventing re-use of the label.

Moreover, providing the option of removing the third label portion from the first and/or second label portions can also assist with waste disposal or recycling practices as described above.

The label may be formed in part from a one-piece sheet of material that extends across the first, second and third label portions. The one or more lines of perforations may be provided in the one-piece sheet of material. The one-piece sheet of material may be a plastic or paper material. For example, the one-piece sheet of material may comprise high-density polyethylene fibres, and may be a flashspun material, for example.

The timer and signalling apparatus may be configured generally in accordance with timers and signalling apparatuses described in other aspects. Actuation of the monitoring of the predetermined time period may use a tab or other mechanism as described above.

Following from the above, according to one aspect of the present disclosure there is provided a wristband comprising:
a first wristband portion, a second wristband portion and a third wristband portion, the third wristband portion being connected to, and located between, the first and second wristband portions;
wherein the third wristband portion comprises a timer to monitor a predetermined time period and a signalling apparatus that provides an alert signal on expiry of the predetermined time period; and
wherein the first and second wristband portions are configured to be fixed together so that the wristband forms a closed loop;
wherein the wristband is formed in part from a one-piece sheet of material that extends across the first, second and third wristband portions;
wherein the third wristband portion is releasably connected to one or both of the first wristband portion and the second wristband portion, the releasable connection between the third wristband portion and the first and/or second wristband portions comprising a frangible element, tear line, tear notch, or perforations.

According to another aspect of the present disclosure there is provided a timer assembly comprising:
a base; and
a timer unit, the timer unit comprising:
   an electronic timer to monitor a predetermined time period; and
   a signalling apparatus that provides an alert signal on expiry of the predetermined time period;
wherein the timer unit is movable relative to the base between at least a first position of contact with the base and a second position of contact with the base, wherein movement of the timer unit to the second position initiates monitoring of the predetermined time period by the electronic timer.

Movement of the timer unit may be carried out by hand, e.g. by a user applying a manual force to the timer unit using their fingers. While movement of the timer unit to the second position initiates monitoring of the predetermined time period by the electronic timer, conversely, the timer assembly may be configured so that movement of the timer unit to the first position turns off monitoring of the predetermined time period by the electronic timer. Additionally, movement of the timer unit to the first position may reset monitoring of the predetermined time period by the electronic timer.

Thus, some forms of the above timer assembly may allow a user to conveniently commence monitoring of a predetermined time period by operation of a single movement, such as movement of the timer unit to the second position. In a setting such as a hospital, where HAIs may be caused by an intravenous cannula remaining too long in a in a patient, a timer assembly with improved usability such as one described in the present document may remove or reduce barriers to use and may lead to improved patient outcomes.

The timer unit may comprise a housing. The electronic timer and the signalling apparatus may be located in and/or on the housing. The timer unit may be mounted to the base and the mounting of the timer unit to the base may be via one or more connection features provided in the housing, e.g. on a surface of the housing.

The timer unit may be movably mounted to the base and may remain in contact with the base as it moves between the first and second positions. The movement between the first and second positions may be linear movement. As such, the timer unit may be slidably mounted to the base. The base may comprise a track, for example, on which the timer unit is slidably mounted. In some embodiments, one end of the track defines the first position and the another end of the track defines the second position.

As an alternative to linear movement, the movement between the first and second positions may be rotational movement. As such, the timer unit may be rotatably mounted to the base. The base may comprise a recess or other receiving element to which the timer unit is rotatably mounted.

The timer unit may comprise a switch that is activated to initiate monitoring of the predetermined time period when the timer unit is moved to the second position. The switch may be a proximity switch such as a magnetic switch, e.g., a reed switch.

The base may comprise a first magnet. Movement of the timer unit to the second position may substantially align the magnetic switch with the first magnet to activate the switch, e.g., to place the switch in an “on” state where monitoring of the predetermined time period is initiated.

To prevent inadvertent movement of the timer unit from at least one of the first and second positions, the timer unit may be releasably held to the base when it is at least at one of the first and second positions, e.g., so that a moderate amount of force must be applied to the timer unit to move the timer unit between the first and second positions. The timer unit may be releasably held by virtue of a magnetic attraction. For example, the timer unit may comprise at least one second magnet that is attracted to a first magnet of the base when the timer unit is at the second position. The first magnet of the base may be the same first magnet that aligns with the switch when the timer unit is at the second position. Additionally or alternatively, the base may comprise a third magnet and the at least one second magnet of the timer unit may be attracted to third magnet of the base when the timer unit is at the first position.

In addition or as an alternative to using a magnetic attraction to releasably hold the timer unit to the base at the first and/or second position, the timer assembly may comprise a locking mechanism or a latch mechanism to releasably hold the timer unit to the base at the first and/or second position. The use of a locking or latch mechanism may prevent a person tampering with the timer assembly.

The mounting of the timer unit to the base may be releasable. The timer unit may be movable to a third position to allow removal of the timer unit from the base. The third position may be between the first and second positions, for example.

The timer unit may comprise a power source such as a battery that may power the electronic timer and the signalling apparatus. The base may not comprise any electronic circuitry for monitoring the predetermined time period and/or for providing an alert signal. In some embodiments, the base may comprise no electronic components. The signalling apparatus may be arranged in accordance with signalling apparatus described above.

The base may be fixable to a support surface, such as at a location that is easily accessible by a user and/or provides a conspicuous location for observation by the user of the alert signal. The base may comprise a fixing portion to fix the base to the support surface. The support surface may be a surface of a product in relation to which the predetermine time period is being monitored. For example, the base may be fixed to a surface of a medical device such as a cannula or endoscope. Alternatively, the base may be fixed to a surface of a hospital bed, a wall, a box or otherwise. The fixing portion may comprise adhesive, a clip, a screw, a strap and/or a hook and loop fastener, for example.
in accordance with discussions above, in one aspect of the present disclosure there is provided a timer unit comprising:
an electronic timer to monitor a predetermined time period; and a signalling apparatus that provides an alert signal on expiry of the predetermined time period;
wherein the timer unit is configured to be moved relative to a base between at least a first position of contact with the base and a second position of contact with the base, wherein movement of the timer unit to the second position initiates monitoring of the predetermined time period by the electronic timer.

In another aspect of the present disclosure there is provided a timer assembly kit comprising:
a base; and
a plurality of timer units, each timer unit comprising:
   an electronic timer to monitor a predetermined time period; and
   a signalling apparatus that provides an alert signal on expiry of the predetermined time period;
wherein each timer unit is selectively usable with the base and movable relative to the base between at least a first position of contact with the base and a second position of contact with the base, wherein movement of the timer unit to the second position initiates monitoring of the predetermined time period by the electronic tinier.

The electronic timers of the plurality of timer units may be configured to monitor different predetermined time periods.

According to one aspect of the present disclosure, there is provided a label assembly comprising:
a timer to monitor a time period and a signalling apparatus that provides an alert signal on expiry of the time period;
a mounting mechanism for mounting the label assembly to an article, the mounting mechanism comprising an elongate portion and a locking portion;
a first face of the label assembly;
a second face of the label assembly; and
a through-hole extending between the first and second faces and comprising the locking portion;
wherein the locking portion is configured to receive the elongate portion to form a closed loop for mounting the label assembly to the article.

The label assembly may comprise a label body, e.g. which at least partially houses the timer and/or the signalling apparatus. The first and second faces may be first and second faces of the label body. The mounting mechanism may be integrated with, or be separable from the label body.

The mounting mechanism may be configured to form a single-use connection, configured such that, after being secured in the through-hole, the elongate portion is not releasable from the through-hole (e.g., without damaging or breaking the mounting mechanism and/or the through-hole).

In general, the elongate portion may have a first end, a second end, and a central region between the first and second ends. The second end may be fixed to the label body e.g. by being integrally formed with or otherwise secured to the label body. Prior to forming a closed loop, the first end may be distal to the label body. To form the closed loop the first end and/or central region may be locked to the locking portion to form the closed loop.

In any aspect disclosed herein, the elongate portion may comprise one or more first teeth and the locking portion may comprise a pawl and/or one or more second teeth adapted to lockingly engage the first teeth. For example, the locking portion may comprise a pawl, the one or more second teeth being located on the pawl.

The mounting mechanism may be single-use. The mounting mechanism may be configured so that, after any opening of the closed loop, the mounting mechanism is broken and/or is no longer operable to form a closed loop to mount to an article.

The timer and signalling apparatus may be configured substantially in accordance with one or more timers and signalling apparatuses as described in other aspects or embodiments. The label assembly may also comprise one or more other features as described in relation to other aspects or embodiments, such as an actuator, a tab or a seal, etc.

Timer devices according to the present disclosure may include features that enable tracking of the device, identification of the device or otherwise. For example, an RFID chip may be comprised in the timer device, e.g. located in or on the timer, under a label or otherwise. Moreover, a QR code or barcode may be comprised in the timer device, e.g. in or on timer, on the label or otherwise. The timer device may have means to remotely communicate with other items, e.g. to enable remote interrogation of the timer device or otherwise.

In any aspect of the present disclosure, where a label, label assembly or tinier device is provided that is configured to be fixed to a support using a fixing portion, at least part of the fixing portion may be transparent or translucent such that the support is at least partially visible through the fixing portion.

Indeed, in one aspect, the present disclosure provides a label comprising:
a timer to monitor a predetermined time period and a signalling apparatus that provides an alert signal on expiry of the time period; and
a fixing portion to fix the label to a support;
wherein at least part of the fixing portion is a transparent or translucent such that the support is at least partially visible through the fixing portion.

The timer and signalling apparatus may be configured generally in accordance with timers and signalling apparatuses described in other aspects. Actuation of the monitoring of the predetermined time period may use a tab or other mechanism as described in other aspects.

The label may be fixed to the support by the fixing portion extending on or at least partially around the support. The fixing portion may be configured to extend around the support and fix to a surface of the support, fix to itself and/or fix to another surface of the label (e.g. by folding). The fixing portion may comprise a fixing element such as an adhesive layer. The fixing portion may comprise a base layer and the adhesive layer may be located on the base layer. Both the base layer and the adhesive layer may be at least partially transparent or translucent. The adhesive layer may be at least partially covered by a releasable backing layer.

The label may have parts that are separable generally in accordance with labels described above. For example, the label may have a first label portion comprising the timer and signalling apparatus, a second label portion comprising the fixing portion, and a frangible element, tear line, tear notch, perforations and/or other region of weakness between the first label portion and the second label portion that enables manual separation of the first label portion from the second label portion.

The transparency or translucency may be provided through use of transparent or translucent polymers and/or clear adhesives, for example.

In another aspect of the present disclosure there is provided a label comprising:
a housing comprising opposing front and rear surfaces, and a plurality of sides surfaces that extend between the front and rear surfaces and define a peripheral edge of the housing;
a timer to monitor a predetermined time period and a signalling apparatus that provides an alert signal on expiry of the time period, the timer and signalling apparatus being at least partially located in the housing;
and one or more fixing elements for fixing the housing to a support surface,
wherein the housing comprises a groove extending at least partially along the peripheral edge of the housing.

The groove may provides a finger grip for the label. The groove may allow a user to grasp the label using their fingers, e.g. in order to manipulate the label when fixing the label to a support surface or when removing the label from a support surface.

Actuation of the monitoring of the predetermined time period may use a tab or other mechanism as described in other aspects. When at least one tab is used, the tab may be released to initiate the monitoring of the predetermined time period. The tab may extend through an opening such as a slot in the housing, the slot being located in the groove of the housing. Accordingly, the slot may be located in a generally recessed position on the outer surface of the housing. This may provide for protection of the slot and may reduce the likelihood of damage of the slot or ingress of contaminants through the slot into the housing. The slot may be associated with a gasket to seal the slot, e.g. in accordance with aspects described above.

In some embodiments, the groove may extend around the entire peripheral edge of the housing. In other embodiments, the groove may extend only partially around the peripheral edge of the housing. For example, the groove may be located at least partially along the first and second side surfaces of the housing only.

The fixing portion may comprise an adhesive layer on the rear surface of the housing. Additionally or alternatively, the fixing portion may comprise one or more magnets. The one or more magnets may be configured for selectively fixing a front or rear surface of the housing to a support surface.

Throughout this specification the word “comprise”, or variations such as “includes”, “has” and “having”, “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

By way of example only, embodiments of the present disclosure are now described with reference to the Figures in which:

FIGS. 1a and 1b show a front view and a rear view, respectively, of a label assembly according to an embodiment of the present disclosure;

FIGS. 2a and 2b show a front oblique exploded view and a rear oblique exploded view, respectively, of the label assembly of FIG. 1a;

FIG. 3 shows a close-up view of an electronics unit and tab portion of the label assembly of FIG. 1a;

FIG. 4 shows a schematic drawing of electronic components of the electronics FIG. 3;

FIGS. 5a to 5e illustrate example processes carried out during use of the label assembly of FIG. 1a;

FIGS. 6a and 6b show a front view and a rear view, respectively, of a label assembly according to another embodiment of the present disclosure;

FIGS. 7a, 7b and 7c show a front view, a rear view and a side view, respectively, of a label assembly according to yet another embodiment of the present disclosure;

FIGS. 8a and 8b show a front view and a rear view, respectively, of a label assembly according to another embodiment of the present disclosure;

FIGS. 9a and 9b show a front view and a rear view, respectively, of a label assembly according to yet another embodiment of the present disclosure;

FIGS. 10a and 10b show a front view and a rear view, respectively, of a label according to an embodiment of the present disclosure;

FIG. 11 shows a cross-sectional side view of the label of FIGS. 10a and 10b fixed to a support surface;

FIGS. 12a, 12b and 12c illustrate example processes carried out during use of the label of FIGS. 10a and 10b;

FIGS. 13a and 13b show a front view and a rear view, respectively, of a label according to another embodiment of the present disclosure;

FIGS. 14a and 14b show a front view and a rear view, respectively, of a label according to another embodiment of the present disclosure;

FIGS. 15a and 15b show a front view and a rear view, respectively, of a label according to another embodiment of the present disclosure;

FIGS. 16a and 16b show front and rear oblique views, respectively, of a timer assembly according to an embodiment of the present disclosure;

FIGS. 17a and 17b show front and rear oblique views, respectively, of a base of the timer assembly of FIGS. 16a and 16b;

FIGS. 18a and 18b show front and rear oblique views, respectively,of a timer unit of the timer assembly of FIGS. 16a and 16b;

FIGS. 19a, 19b, and 19c show front oblique views of the timer assembly of FIGS. 16a and 16b with the timer unit in an on, off, and removal position, respectively;

FIGS. 20a, 20b, and 20c show rear views of the timer assembly of FIGS. 16a and 16b with the timer unit in an on, off, and removal position, respectively;

FIG. 21 shows an exploded view of the timer unit of the timer assembly of FIGS. 16a and 16b;

FIG. 22 shows a schematic illustration of electronic components of the timer unit of FIG. 21;

FIG. 23 shows an exploded view of the base of the timer assembly of FIGS. 16a and 16b;

FIGS. 24a shows a front view of the timer assembly of FIGS. 16a and 16b; and FIG. 24b shows a cross-sectional view of the tuner assembly along line A-A of FIG. 24a;

FIGS. 25a and 25b show front views of a base and a timer unit, respectively, according to another embodiment of the present disclosure;

FIGS. 26a and 26b show front views of a timer assembly that includes the base and timer unit of FIGS. 25a and 25b, the tuner assembly being in an on and off position, respectively;

FIG. 27 shows a rear oblique view of the timer assembly of FIG. 16b including a fixing portion;

FIG. 28a shows an oblique front view of a label assembly, including a mounting mechanism, according to an embodiment of the present disclosure, FIG. 28b shows the label assembly with the mounting mechanism in a configuration to mount to an article; and FIG. 28c shows a sealing mechanism employed in the label assembly;

FIGS. 29a and 29b show a front view and side view, respectively, of a label according to another embodiment of the present disclosure;

FIG. 30 shows example use of the label of FIGS. 29a and 29b;

FIGS. 31a and 31b show a front view and side view, respectively, of a label according to another embodiment of the present disclosure;

FIGS. 32a and 32b show a front view and side view, respectively, of a label according to another embodiment of the present disclosure;

FIG. 33 shows example use of the label of FIGS. 32a and 32b;

FIGS. 34a and 34b show a front view and rear view, respectively, of a label according to another embodiment of the present disclosure;

FIGS. 35a and 35b show a left side view and right side view, respectively, of the label of FIGS. 34a and 34b;

FIGS. 36a and 36b show a front view and rear view, respectively, of a label according to another embodiment of the present disclosure; and

FIGS. 37a and 37b show a left side view and right side view, respectively, of the label of FIGS. 36a and 36b.

### DESCRIPTION OF EMBODIMENTS

Examples of timer devices, such as a label assembly, label, or timer assembly will be described in further detail below, including with reference to figures.

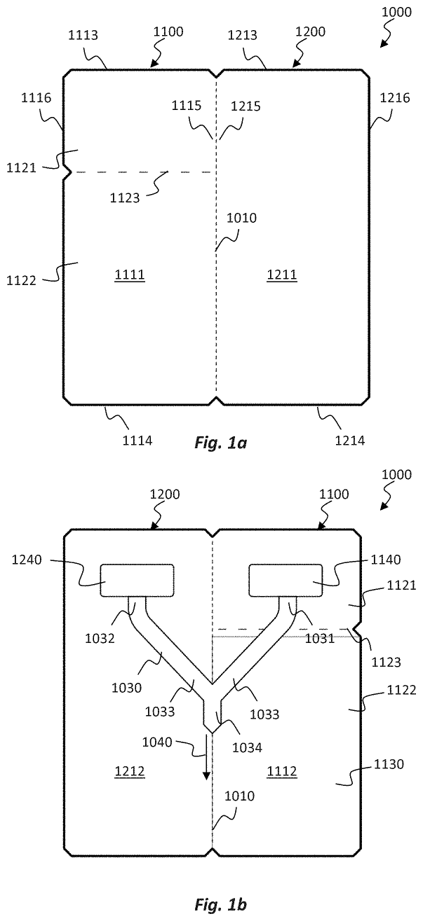

Front and rear views of a label assembly 1000 according to an embodiment of the present disclosure are shown in FIGS. 1a and 1b. The label assembly 1000 includes a first label 1100 and a second label 1200. As explained in further detail below, the first label 1100 includes a first timer to monitor a predetermined time period and a first signalling apparatus that provides an alert signal on expiry of the predetermined time period, and the second label 1200 includes a second tinier to monitor the predetermined time period and a second signalling apparatus that provides an alert signal on expiry of the predetermined time period. The first and second labels 1100, 1200 are releasably connected to each other and are configured to monitor the predetermined time period, starting at the same time.

In this embodiment, the first label 1100 has a substantially planar configuration, wherein the first label 1100 has a first dimension (e.g. thickness) significantly smaller than its other dimensions (e.g. length and/or width). The first label 1100 may be further configured with substantially rectangular front and rear surfaces 1111, 1112, a first end edge 1113, a second end edge 1114, an inner side edge 1115 and an outer side edge 1116. The length direction of the label 1100 extends between the first and second end edges 1113, 1114 and the width direction of the label 1100 extends between the inner and outer sides edges 1115, 1116.

Similarly, the second label 1200 has a substantially planar configuration, with substantially rectangular front and rear surfaces 1211, 1212, a first end edge 1213, a second end edge 1214, an inner side edge 1215 and an outer side edge 1216. The length direction of the label 1200 extends between the first and second end edges 1213, 1214 and the width direction of the label 1200 extends between the inner and outer side edges 1215, 1216.

As indicated, the first and second labels 1100, 1200 are releasably connected to each other. The connection in this embodiment is between the inner side edges 1115, 1215 such that the first and second labels 1100, 1200 are releasably connected in a side-by-side configuration. The releasibility of the connection is provided through the inclusion at the connection of a first line of perforations 1010. The first line of perforations 1010 extends substantially the entire length of the inner side edges 1115, 1215 of the first and second labels 1100, 1200. Thus, the first and second labels 1100, 1200 can be manually disconnected from each other by a user of the label assembly tearing the label assembly 1000 along the first line of perforations 1010. In other embodiments of the present disclosure, the connection between the first and second labels 1100, 1200 may include a frangible element, tear line, tear notch and/or other region of weakness in addition to or as an alternative to perforations. The releasable connection, or perforation 1010, may also be visible to a user thus providing a visual guide to separate the first and second labels.

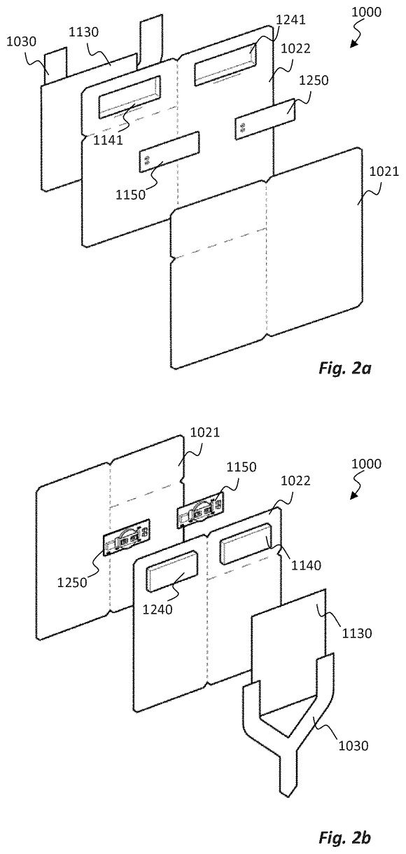

As can be seen from the exploded views of FIGS. 2a and 2b, the label 1000 has, primarily, a three-layer construction, including a front panel 1021, a rear panel 1022 and a releasable backing layer 1130. The front and rear panels 1021, 1022 each extend across the full length and width of the label assembly 1000 and are shared by the first and second labels 1100, 1200. The first and second labels 1100, 1200 are therefore integrally formed.

In the length direction of the first label 1100, the first label 1100 is divided into a first portion 1121 and a second portion 1122, the first and second portions 1121, 1122 being located at opposite sides of a second line of perforations 1123 of the label assembly 1000. The first portion 1121 is located toward the first end edge 1113 of the first label 1100 and the second portion 1122 is located towards the second end edge 1114 of the first label 1100. The second line of perforations 1123 extends between the inner and outer side edges 1115, 1116 of the first label 1100 in the width direction of the label 1100. The first portion 1121 is smaller than the second portion 1122. Both the first portion 1121 and the second portion 1122 extend across the full width of the first label 1100. The second portion 1122 extends across a greater length of the first label 1100 than the first portion 1121. The first portion 1121 is separable from the second portion 1122 by virtue of a user tearing along the second line of perforations 1123.

In normal use of the label assembly 1000, it is expected that the first and second labels 1100, 1200 will be separated from each other prior to any separation of the first and second portions 1121, 1122 of the first label 1100. To reduce any risk that separating the first and second labels 1100, 1200 along the first line of perforations 1100 could inadvertently cause separation of the first and second portions 1121, 1122, the perforations of the second line of perforations 1123 are distributed less frequently than the perforations of the first line of perforations 1010, rendering the connection between the first and second portions 1121, 1122 stronger than the connection between the first and second labels 1100, 1200.

The first portion 1121 of the first label 1100 includes a fixing portion to fix the label to a support surface, e.g. after separation of the first and second labels. The fixing portion comprises adhesive in this embodiment to fix the label to the support surface. The adhesive is covered by the backing layer 1130, the backing layer being releasable, e.g. by peeling, to expose the adhesive. The second portion 1121 includes a first electronics unit 1150, the first electronics unit 1150 being described in more detail below.

The first and second labels 1100, 1200 are each substantially flat, except at a region where each of the labels 1100, 1200 includes a respective housing 1140, 1240 and electronics unit 1150, 1250. In particular, the first label 1100 includes a first housing 1140 for a first electronics unit 1150 and the second label 1200 includes a second housing 1240 for a second electronics unit 1250. The first and second housings 1140, 1240 are each formed by a surface portion of the front panel 1021 and an opposing relief 1141, 1241 formed in the rear panel 1022, the relief 1141, 1241 projecting rearward relative to the remainder of the rear panel 1022.

The first and second electronics units 1150, 1250 are substantially identical to each other in this embodiment. For simplicity, components and functions of the electronics units are generally discussed below with reference to the first electronics unit 1150 only.

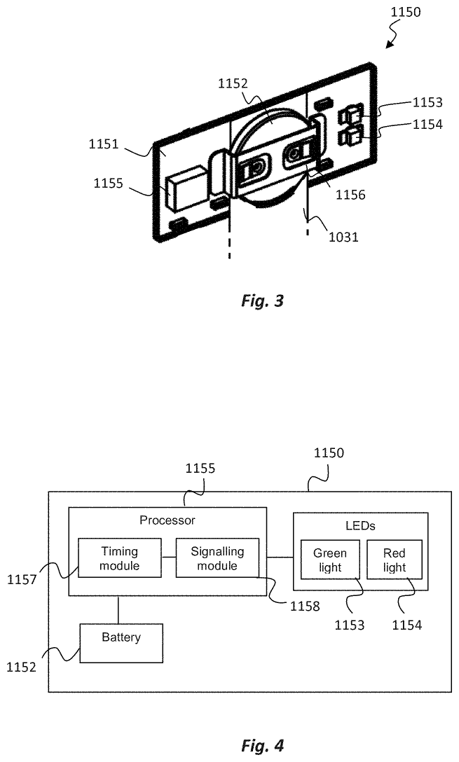

A close-up view of the first electronics unit 1150 is provided in FIG. 3. The electronics unit 1150 includes a printed circuit board (PCB) 1151 on which a battery 1152 is mounted along with a first LED 1153, a second LED 1154 and a processor (microchip) 1155. The battery 1152 provides a source of power for the LEDs 1153, 1154 and the processor 1155.

Each of the first and second electronics units 1150, 1250 provide the respective timer to monitor the predetermined time period and the respective signalling apparatus to provide the alert signal on expiry of the predetermined time period. Referring to FIG. 4, which provides a schematic illustration of components of the first electronics unit 1150, the timer is provided at least in part by a timing module 1157 of the processor 1155, and is configured in this embodiment to start timing when electricity is supplied to the processor 1155 from the battery 1152. The signalling apparatus is controlled by a signalling module 1158 of the processor 1155 and provided at least in part by the first and/or second LEDs 1153, 1154.

Electricity is provided to the processor 1155, and to the LEDS 1153, 1554, via an electrical circuit including the PCB 1151. Referring again to FIG. 3, the electrical circuit is connected to the battery 1152 by a first electrical contact (not visible) and a second electrical contact 1156. The first electrical contact is positioned on the PCB 1151, underneath the battery 1152, to electrically contact a first terminal of the battery 1151. The second electrical contact 1156 is provided by a flexible conductive arm that forms a bridge from the PCB 1151 over the battery 1152 to electrically contact a second terminal of the battery 1152. The second electrical contact 1156 also clips the battery 1152 in place, holding it firmly in position against the PCB 1151.

In this embodiment, the label assembly 1000 includes a common actuator 1030 to initiate the monitoring of the predetermined time period by the first and second timers of the first and second labels 1100, 1200. Referring to FIG. 1b, for example, the common actuator is provided by a tab 1030 and specifically a bifurcated tab 1030. The tab 1030 has a first proximal end 1031 that extends into the first housing 1140 and a second proximal end 1032 that extends into the second housing 1240. The tab 1030 comprises a bridge section 1033 that extends between and connects together the first and second ends 1031, 1032. The tab 1030 comprises a third, distal end 1034 that is connected to the bridge section 1033 and which is engageable by the user to pull the tab 1030.

Referring to FIG. 3, the first end 1031 of the tab 1030, which is non-conductive, is positioned under the battery 1152 between the first terminal of the battery 1152 and the first electrical contact of the PCB 1151. While the first end 1031 is in this position, the first electrical contact is insulated from the first terminal of the battery 1152 by the tab 1030 and the electrical circuit is therefore incomplete (open). In this state, electricity cannot flow from the battery 1152 to other components of the electronics unit including the processor 1155. However, when the first end 1031 of the tab 1030 is removed, e.g. as a result of a user pulling the third end 1034 of the tab 1030 in a direction 1040 away from the electronics unit 1150 as indicated in FIG. 1b, the first terminal of the battery 1152 and the first electrical contact are configured to touch so as to complete (close) the electrical circuit. When complete, electricity can flow from the battery 1152 to the processor 1155, which can provide a trigger to initiate monitoring of the predetermined time period by the first timer.

This arrangement is repeated in the second label 1200, between the corresponding components of the second electronics unit 1250 and the second end 1032 of the tab 1030.

The LEDs 1153, 1154 are each visible at the front surfaces 1111, 1211 of the first and second labels through translucent material that is at least partially used to form the first panel 1021 of the label assembly 1000.

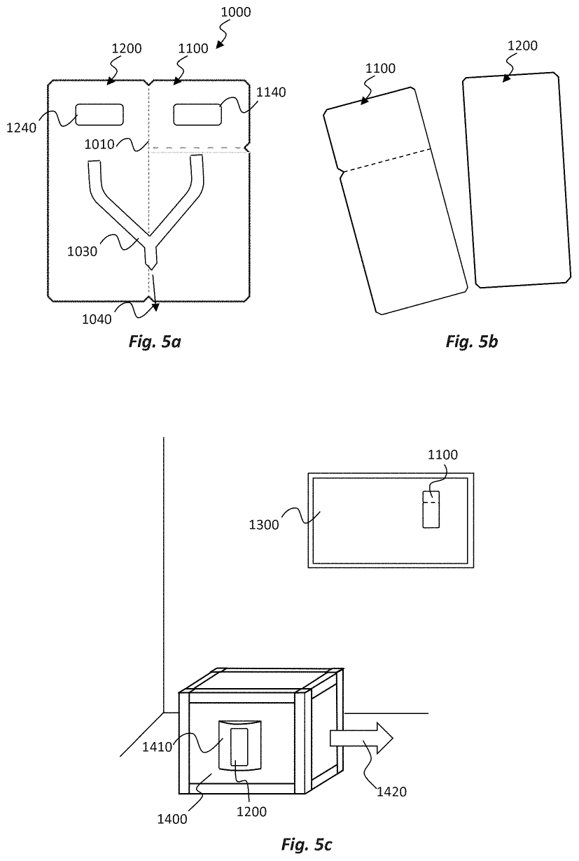

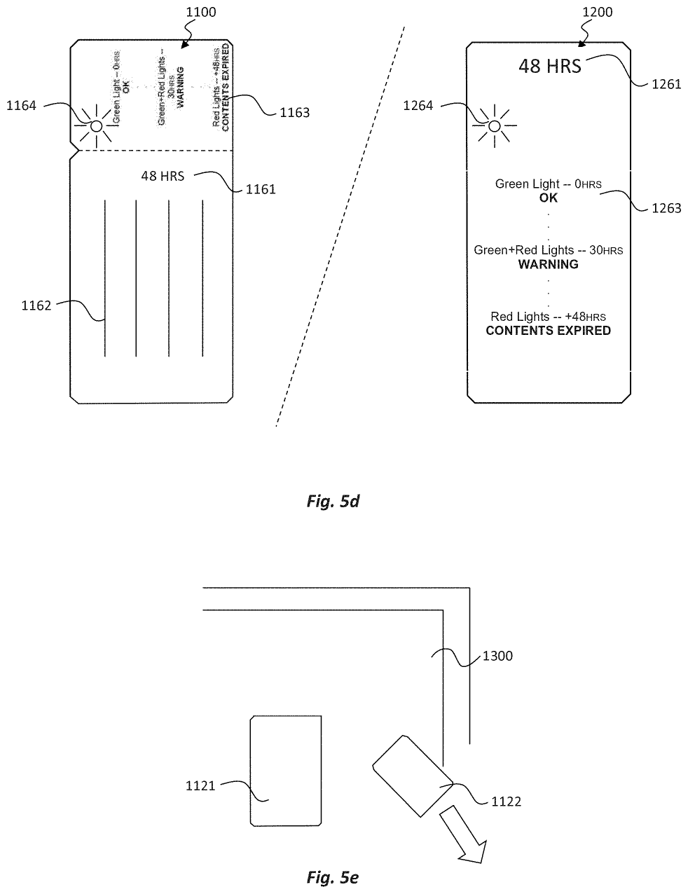

Example use of the label assembly 1000 is now described with reference to FIGS. 5a to 5e. In this example, the label assembly 1000 is a shipping label assembly, and the predetermined time period that is to be monitored by the first and second labels 1100, 1200 relates to an item that is shipped from a dispatch location.

Referring to FIG. 5a, a user can hold the label assembly 1000 in one hand and pull the tab 1030 with their other hand, in a direction generally indicated by arrow 1040, so that it releases from the first and second electronics units 1150, 1250 located within the first and second housings 1140, 1240 and initiates monitoring of the predetermined time period by the first and second timers at the same time.

Referring to FIG. 5b, a user can then disconnect the first and second labels 1100, 1200 from each other by tearing the label assembly 1000 along the first line of perforations 1010. (In alternative embodiments, a user may disconnect the first and second labels prior to initiating monitoring of the predetermined time period by the first and second timers.)

Referring to FIG. 5c, a user, at the despatch location for the item, can fix the first label 1100 to a surface such as a whiteboard 1300 (or wall, notice board, or other surface that is readily observed or observable) and fix the second label 1200 to a shipping parcel or crate 1400 that contains the item relating to which the predetermined time period is monitored. In particular, in this example the second label 1200 is located in a pouch 1410 that is fixed to an outer surface of the crate 1400 and which may also contain shipping documentation, etc. The item may then be shipped, as generally represented by arrow 1420 in FIG. 5c, to its intended destination.

A representation of the first and second labels 1100, 1200, at different locations, is provided in FIG. 5d. In FIG. 5d, it can be seen that different information is printed on the first and second labels 1100, 1200. For example, the specific predetermined time period 1161, 1261 that the labels 1100, 1200 are configured to monitor is printed on each label 1100, 1200 (in this example the time period is 48 hours). Further, on the second portion of the first label 1100, a section 1162 is provided where a user can write information on the first label 1100, including, for example, any one or more of: the time and date of dispatch, the name of the sender, the name of the intended recipient, an indication of whether the item was received in time, the time of receipt, the date of receipt, and a signature, etc. Moreover, on each label 1100, 1200, information 1163, 1263 is printed to help a user interpret alerts provided by the signalling apparatus, and particularly light signals 1164, 1264 emitted from the first and/or second LEDs of the signalling apparatus of each label 1100, 1200.

In this embodiment, three different types of alert signals are provided by the labels 1100, 1200 of the label assembly 1000: flashing green light; flashing green and red light; and flashing red light. The flashing green light is issued during a first time portion following initiation of monitoring of the predetermined time period (in this example from 0 hours to 30 hours), indicating that there is still a considerable amount of the predetermined time period that remains The flashing green and red light is issued during a second time portion that follows the first time portion and is prior to expiry of the predetermined time period, providing a warning that expiry of the predetermined time is relatively soon or imminent. Finally, the flashing red light is issued upon expiry of the predetermined time period.

Prompted by the alert signals from the labels 1100, 1200, a user may elect to perform a check in relation to the shipped item or take other action. For example, based on alert signals from the first label 1100, a person at the despatch location may check records or even contact the intended recipient and/or shipping contractor to determine if the item has been received in suitable time, to determine it the item is due to be received in time and/or to determine if a necessary action has been taken in relation to the received item. As another example, based on alert signals from the second label 1100, a shipping contactor may choose to expedite delivery of the item.

As described above, the first label 1100 includes a first portion 1121 and a second portion 1122, which are separable from each other. The first portion 1121 is fixed, using the adhesive, to the support surface (e.g. the whiteboard 1300 as shown in FIG. 5c), On the other hand, the second portion 1122 does not comprise any adhesive and can be separated, after expiry of the predetermined time period, along the second line of perforations 1123, from the first portion 1121, generally as illustrated in FIG. 5e. The first portion 1121 can therefore remain as a record for the monitoring of the predetermined time period. The first portion 1121 may be retained on the support surface 1300 or moved to another surface, e.g. to a records folder. On the other hand, the second portion 1122, including the relatively bulky electronic elements, can be disposed of, e.g., using appropriate c-waste or e-recycling techniques.

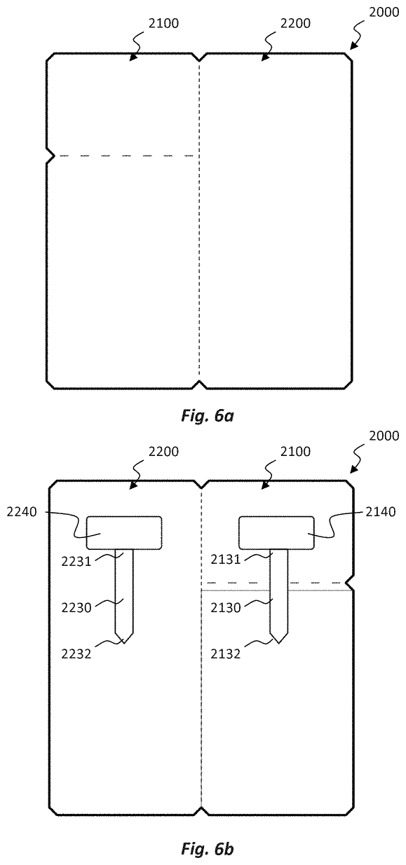

A label assembly 2000 according to another embodiment of the present disclosure is illustrated in FIGS. 6a and 6b. The label assembly 2000 includes a first label 2100 and a second label 2200 and is substantially identical in form and function to the label assembly 1000 described above, except with regards the actuator to initiate the monitoring of the predetermined time period by the first and second timers of the first and second labels 2100, 2200. In this embodiment, the label assembly 2000 includes two separate actuators, rather than a common actuator, to initiate the monitoring of the predetermined time period by the first and second timers of the first and second labels 2100, 2200. The actuators are provided by a first tab 2130 and a second tab 2230. The first tab 2130 has a proximal end 2131 that extends into the first housing 2140 of the first label 2100 to interact with the electronics unit within the first housing 2140 and an opposite distal end 2132 that is engageable by the user to pull the tab 2130. Similarly, the second tab 2230 has a proximal end 2231 that extends into the second housing 2240 of the second label 2200 to interact with the electronics unit within the second housing 2240 and an opposite distal end 2232 is engageable by the user to pull the tab 2230. The arrangement of tabs 2230, 2240 enables a user of the label assembly to initiate monitoring of the predetermined time period by the first and second timers by pulling the tabs 2130, 2230 simultaneously or in quick succession, effectively causing the timers to monitor the predetermined time period at the same time.

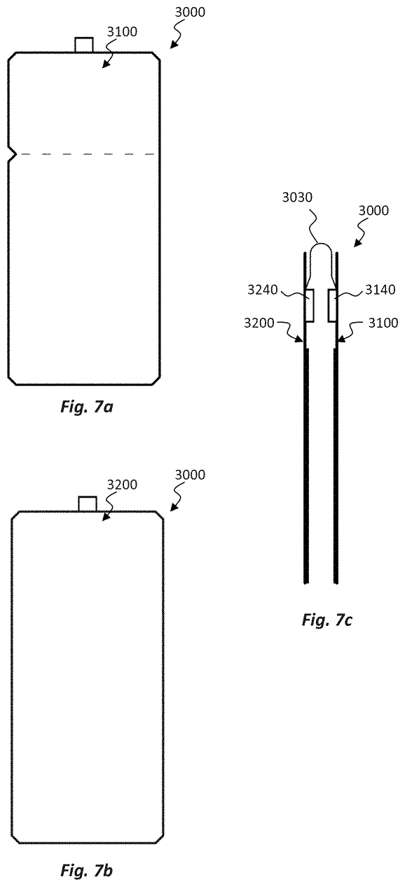

A label assembly 3000 according to yet another embodiment of the present disclosure is illustrated in FIGS. 7a, 7b and 7c. The label assembly 3000 includes a first label 3100 and a second label 3200 and is similar in form and function to the label assembly 2000 described above with reference to FIGS. 6a and 6b, except that: the first and second labels 3100, 3200 are positioned in a stacked, back-to-back configuration, rather than being side-by-side; and the common actuator, provided by a single tab 3030 in this embodiment, loops between the first and second housings 3140, 3240 of the first and second labels 3100, 3200. The user may place a finger underneath the loop of the tab 3030 to pull the tab from the housings 3140, 3240. By positioning the first and second labels 3100, 3200 back-to-back (or front-to-front, front-to-back or back-to-front in alternative arrangements), storage and/or distribution of the label assembly 3000 may be more convenient. The labels 3100, 3200 are positioned in an aligned arrangement as shown in FIG. 7c, with the first and second housings 3140, 3240 directly opposing each other. In alternative embodiments, the labels 3100, 3200 may be misaligned, e.g. vertically misaligned, so that the first and second housings 3140, 3240 are positionable in an interleaved configuration, enabling a depth of the label assembly to be reduced in size.

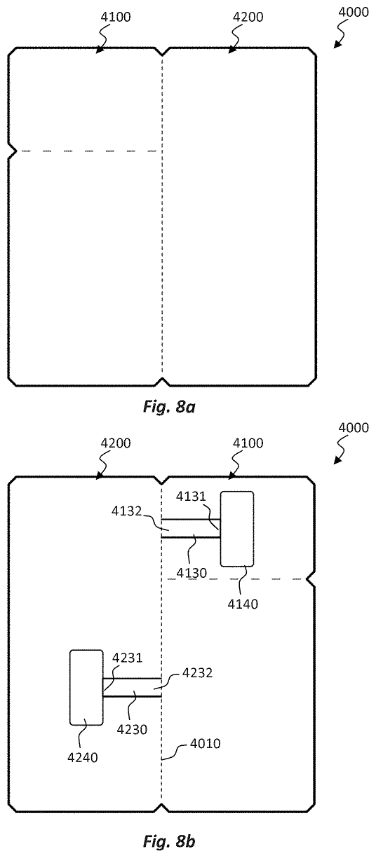

A label assembly 4000 according to another embodiment of the present disclosure is illustrated in FIGS. 8a and 8b. The label assembly 4000 includes a first label 4100 and a second label 4200 and is similar to the label assembly 2000 described above with reference to FIGS. 6a and 6b, except that: the first and second housings 4140, 4240, containing the electronics units, are oriented differently; and, related to this, the distal ends 4132 of the first and second tabs 4130, 4230 that extend from the housings are fixed to the respective opposing label 4100, 4200. In particular, the first tab 4130 has a proximal end 4131 that extends into the first housing 4140 of the first label 4100 to interact with the electronics unit within the first housing 4140 and an opposite distal end 4132 that is fixed to the second label 4200. Similarly, the second tab 4230 has a proximal end 4231 that extends into the second housing 4240 of the second label 4200 to interact with the electronics unit within the second housing 4240 and an opposite distal end 4232 that is fixed to the first label 4100. The distal ends 4132, 4232 can be fixed to the respective first and second labels 4100, 4200 by being sandwiched and/or adhered between panels that form the first and second labels 4100, 4200. The arrangement of tabs 4130, 4230 is such that, when the first and second labels 4100, 4200 are disconnected, e.g. along a line of perforations 4010 between the first and second labels 4100, 4200, and pulled away from each other, the first and second tabs 4130, 4230 are automatically pulled from their respective housings 4140, 4240. Thus, the step of disconnecting the first and second labels 4100, 4200 from each other causes initiating of the monitoring of the predetermined time period by the first and second labels 4100, 4200.

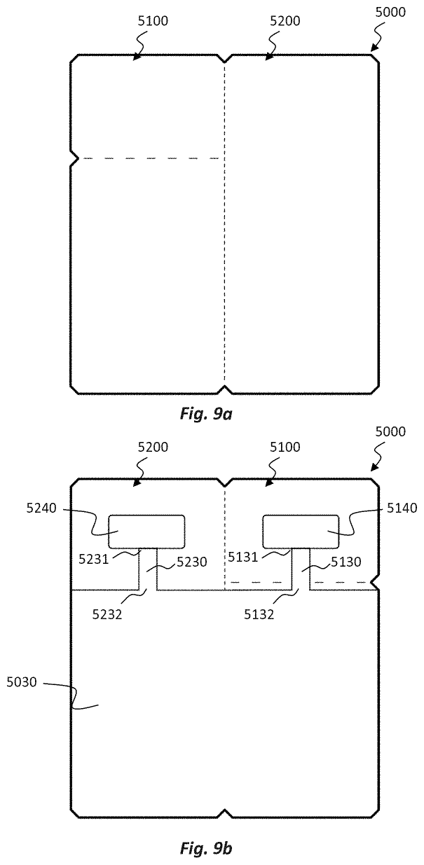

A label assembly 5000 according to yet another embodiment of the present disclosure is illustrated in FIGS. 9a and 9b. The label assembly 5000 is similar to the label assembly 2000 described above with reference to FIGS. 6a and 6b, except that the releasable backing layer 5030 that covers the adhesive fixing portion of the first label 5100 extends across both labels 5100 and 5200 of the label assembly 5000, and the first and second tabs 5130, 5230 that extend from the first and second housings 5140, 5240 are each fixed to the backing layer 5030. In particular, the first tab 5130 has a proximal end 5131 that extends into the first housing 5140 of the first label 5100 to interact with the electronics unit within the first housing 5140 and an opposite distal end 5132 that is fixed to the backing layer 5030. Similarly, the second tab 5230 has a proximal end 5231 that extends into the second housing 5240 of the second label 5200 to interact with the electronics unit within the second housing 5240 and an opposite distal end 5232 that is fixed to the backing layer 5030. The arrangement enables a user of the label assembly 5000 to initiate monitoring of the predetermined time period by the first and second timers by releasing the backing layer. Releasing (e.g. peeling) of the backing layer 5030 causes the first and second tabs to be automatically pulled from their respective housings 5140, 5240. In this arrangement, the combination of the first and second tabs 5130, 5230 and the backing layer 5030 can be considered to provide a common actuator to initiate monitoring of the predetermined time period.

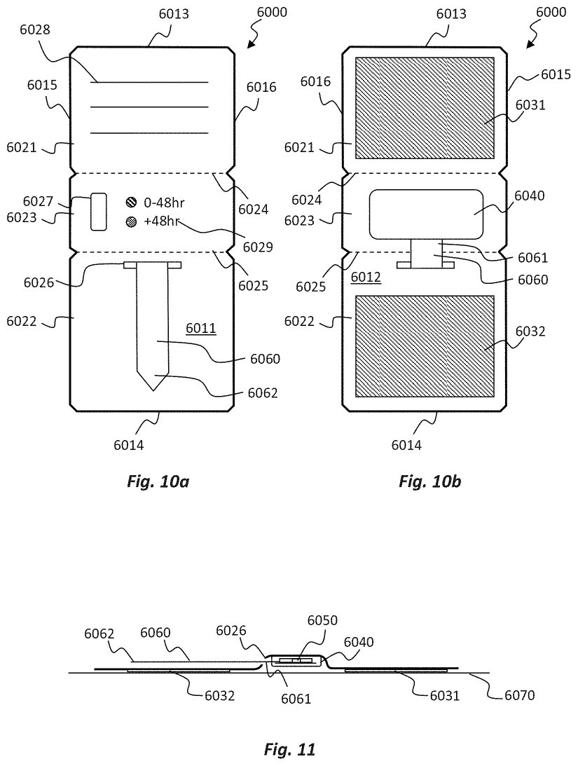

Front and rear views of a label 6000 according to another embodiment of the present disclosure are shown in FIGS. 10a and 10b. Like preceding embodiments, the label 6000 includes a timer to monitor a predetermined time period and a signalling apparatus that provides an alert signal on expiry of the predetermined time period.

The label 6000 has a substantially planar configuration, with substantially rectangular front and rear surfaces 6011, 6012, a first end edge 6013, a second end edge 6014, a first side edge 6015 and a second side edge 6016. The length direction of the label 6000 extends between the first and second end edges 6013, 6014 and the width direction of the label 6000 extends between the first and second side edges 6015, 6016.

In the length direction of the label 6000, the first label 6000 includes a first portion 6021, a second portion 6022 and a third portion 6023, the first portion 6021 being located towards the first end 6013 of the label 6000, the second portion 6022 being located towards the second end 6014 of the label 6000 and the third label portion 6023 being located between the first and second label portions 6021, 6022.

In this embodiment, a first line of perforations 6024 extends between the first and second side edges 6015, 6016 of the label 6000 in the width direction of the label 6000, directly between the first and third label portions 6021, 6023, and a second line of perforations 6025 extends between the first and second side edges 6015, 6016 of the label 6000 in the width direction of the label 6000, directly between the second and third label portions 6022, 6023. The third label portion 6021 is therefore separable from the first and second label portion 6021, 6022 by a user tearing along the first and second lines of perforations 6024, 6025.

The first and second label portions 6021, 6022 include respective first and second fixing portions 6031, 6032 to fix the label 6000 to a support surface. In this embodiment, the first and second fixing portions 6031, 6032 each comprise a layer of adhesive covered by a releasable backing layer. The backing layers are releasable, e.g. by peeling, to expose the adhesive.

The label 6000 is substantially flat, except at a region where it includes a housing 6040, an electronics unit 6050 (see FIG. 11) being located in the housing 6040. In this embodiment, the housing 6040 and electronic unit 6050 are provided in the third portion 6023 of the label 6000. The housing 6040 and the electronics unit 6050 are formed in a similar or identical manner to the housing 1140 and electronics unit 1150 described above with reference to FIGS. 2a to 4. The electronics unit 6050 again comprises the timer to monitor the predetermined time period and the signalling apparatus that provides an alert signal on expiry of the predetermined time period. In this embodiment, the alert signal is provided by one or more LEDs that are visible through a window 6027 at the front surface of the third label portion 6023.

The label 6000 includes an actuator to initiate the monitoring of the predetermined time period by the timer. In this embodiment, the actuator is provided by a tab 6060. The tab 6060 has a proximal end 6061 that extends into the housing 6040 to interact with components of the electronics unit 6050 within the housing 6040 and an opposite distal end 6062 that is engageable by the user to pull the tab 6060 from the housing 6040. Pulling the tab 6060 can initiate the monitoring of the predetermined time period by allowing completion of an electrical circuit in the electronics unit 6050 in a similar manner to that described above with reference to the electronics unit 1150 of FIG. 3. Although an actuator in the form of a tab is described in this and various other embodiments, the actuator in this and other embodiments may alternatively comprise a button or a slider that is pressed or slid by a user to initiate the monitoring, or may comprise a magnetic switch that is operable by moving relative to or into a magnetic field. Other types of actuators may also be used.

The label 6000 is configured so that the first and second fixing portions 6031, 6032 can fix the label 6000 to a support surface in a secure manner, the fixing occurring at either side of the third label portion 6023 that includes the electronics unit/timer. Fixing of the label 6000 to a support surface 6070, using the first and second fixing portions 6031, 6032 is illustrated in FIG. 11. Using the first and second fixing portions 6031, 6032 to fix the label 6000 to a support surface 6070 contrasts, for example, with an arrangement where a label is fixed to a support surface using a fixing portion to one side of the electronics unit/timer only, e.g., as described in preceding embodiments. Using the first and second fixing portions 6031, 6032 may reduce the risk that the label 6000 is unintentionally released from the support surface 6070, e.g., by a loose end of the label 6000 being caught and/or pulled by mistake.

As can be seen in FIG. 11, the housing 6040 containing the electronics unit 6050 is situated at a rear of the label 6000 where it faces or even contacts the support surface 6070. So that the tab 6060 is accessible to a user when the label 6000 is fixed to the support surface 6070, the distal end 6062 of the tab 6000 extends through an opening 6026 in the label 6000 to the front side of the label 6000, the opening 6026 reaching between the front and rear surfaces 6011, 6012 of the label 6000 and specifically at the second label portion 6022 of the label 6000 in this embodiment. Thus, the tab 6060 is connected to the electronics unit 6050 at the rear surface 6012 of the label 6000 while being accessible from the front surface 6011 of the label 6000 to the user.

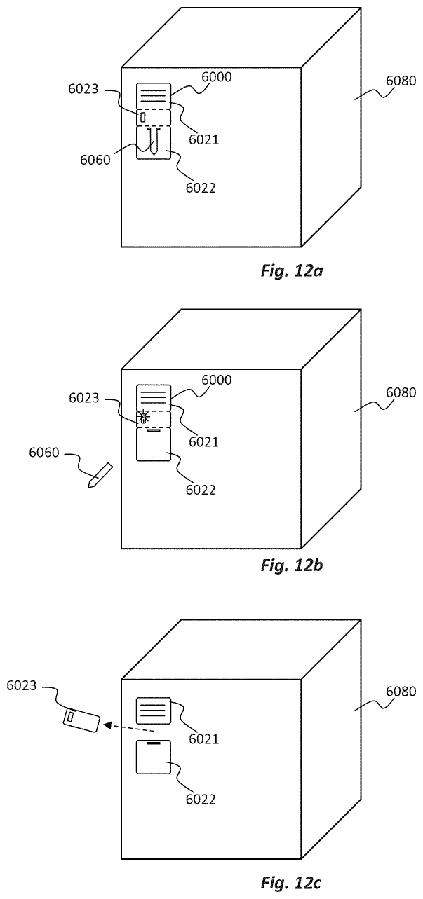

With reference to FIG. 12a, in use the label 6000 may be fixed, using the first and second fixing portions 6022, 6023, in one example, to an item that is shipped, such as a parcel, a crate or a container 6080 as represented in this embodiment. The user can initiate monitoring of the time period after a product is packed in the container 6080, for example. The label 6000 may be selected to monitor a predetermined time period that is based on a period by which the contents of the container 6080 is guaranteed to be safely kept at temperature, for example. The contents may include, for example, biological material such as tissue grafts or non-medical items such as food or otherwise. The container 6080 may provide for cold-transport of a product, such as biological material or food, for example.

Before or after the label 6000 is fixed to the container 6080, the user can initiate monitoring of the predetermined time period by pulling and removing the tab 6060, as shown in FIG. 12b. In this embodiment, two different types of visual alert signals are provided by LEDs included in the electronics unit 6050 of the third label portion 6023. A green light is issued during a first time portion following initiation of monitoring of the predetermined time period, up to expiry of the predetermined time period and a red light is issued following expiry of the predetermined time period.

After expiry of the predetermined time period and/or after any necessary action has been taken in relation to the container 6080, e.g., delivery of the container, removal of the contents of the container, or use of the contents, the third label portion 6023 can be removed from the label 6000, as illustrated in FIG. 12c. Removal can be carried out by tearing the label across the first and second lines of perforations 6024, 6025. Removing of the third label portion 6023 may allow the container 6080 to be recycled or otherwise disposed of without complications that might be caused by electronic components being attached to the item 6080. Additionally or alternatively, it can allow the electronic components to be recycled or otherwise disposed of in an appropriate manner. The first and second label portions 6021, 6022 may remain fixed to the item 6080 during recycling or disposal.

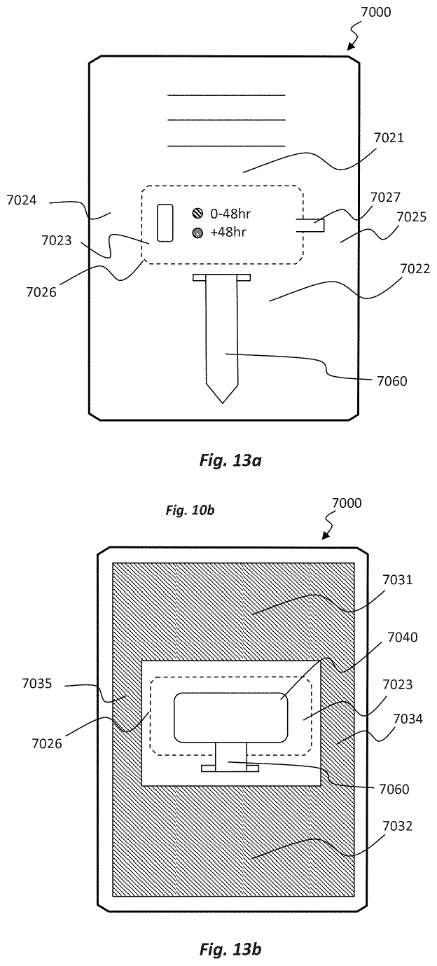

Front and rear views of a label 7000 according to another embodiment of the present disclosure are shown in FIGS. 13a and 13b. The label 7000 is very similar to the label 6000 described with reference to FIGS. 10a to 12c, except that its third label portion 7023 is not only positioned between first and second label portions 7021, 7022, located on opposite sides of the third label portion 7023 in a first direction of the label 7000, but is also positioned between fourth and fifth label portions 7024, 7025 located on opposite sides of the third label portion 7023 in a second, transverse, direction of the label 7000. The periphery of the third label portion 7023 is therefore entirely surrounded by other portions of the label 7000.

In this embodiment, first and second fixing portions 7031, 7032 comprised in the first and second label portions 7021, 2022 are joined together by virtue of fourth and fifth fixing portions 7034, 7035 comprised in the fourth and fifth label portions 7024, 7025. The periphery of the third label portion 7023 is therefore entirely surrounded by fixing portions of the label 7000. The fixing portions are provided by different regions of an adhesive layer (optionally covered by a backing layer) that entirely surrounds the third label portion 7023. Again, however, the third label portion 7023 does not include any fixing portion.

In this embodiment, after monitoring of a predetermined time period, again through use of an electronics unit comprised in a housing 7040, the monitoring being initiated by pulling of a tab 7060, the third label portion 7023 is separable from the first and second label portions 7021, 7022 (and also from the fourth and fifth label portions 7024, 7025) by virtue of tearing across lines of perforation 7026 that extend between the label portions. To assist a user with engaging and tearing off the third label portion 7023, a further tab 7027 is provided, that is fixed to and projects from the third label portion 7023. In this embodiment, the lines of perforation 7026 may define a periphery of the third label portion 7023.

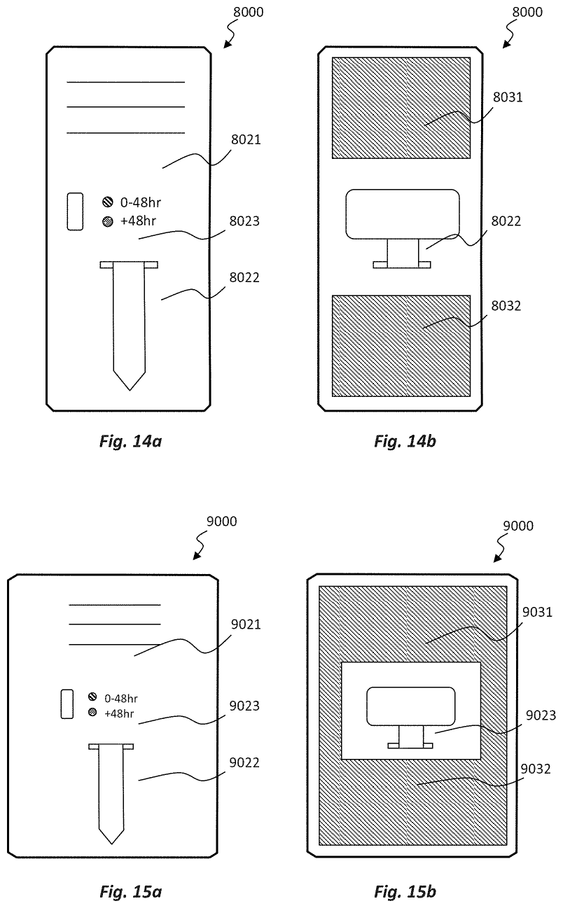

Labels 8000, 9000 according to two further embodiments of the present disclosure are illustrated in FIGS. 14a to 15b. The label 8000 illustrated in FIGS. 14a and 14b is substantially identical to the label 6000 described above, the label 8000 including first and second label portions 8021, 8022, having discrete first and second fixing portions 8031, 8032 and a third label portion 8023 comprising a timer and signalling apparatus that is connected to and located between the first and second label portions 8021, 8022. However, the label 8000 does not include any regions of weakness (e.g. lines of perforation) to enable manual separation of the first and second label portions 8021, 8022 from the third label portion 8023. Similarly, the label 9000 illustrated in FIGS. 15a and 15b is substantially identical to the label 7000 described above, the label 9000 including first and second label portions 9021, 9022, having conjoined first and second fixing portions 9031, 9032, and a third label portion 9023 comprising a timer and signalling apparatus that is connected to and located between the first and second label portions 9021, 9022. However, the label 9000 does not include any regions of weakness (e.g. lines of perforation) to enable manual separation of the first and second label portions 9021, 9022 from the third label portion 9023.

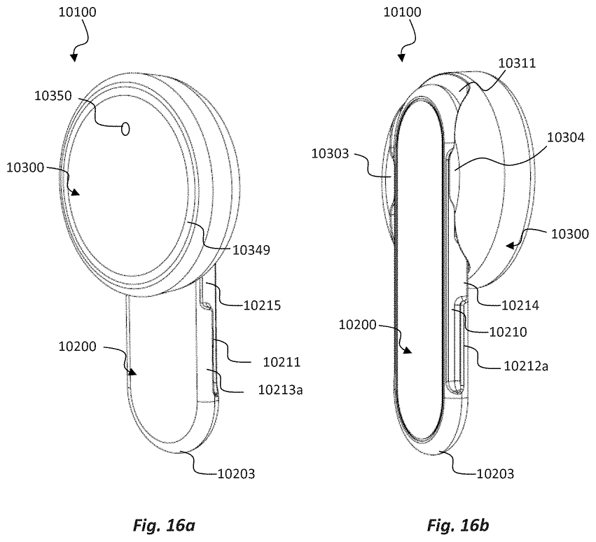

A timer assembly 10100 according to an embodiment of the present disclosure is illustrated in FIGS. 16a and 16b. The timer assembly includes a base 10200 and a timer unit 10300. As discussed in more detail below, the timer unit 10300 is movable relative to the base 10200, and in particular is slidable relative to the base 10200. Sliding of the timer unit 10300 relative to the base 10200 is used to initiate monitoring of a predetermined time period by an electronic timer of the timer unit 10300, the timer unit 10300 also including signalling apparatus that provides an alert signal on expiry of the predetermined time period.

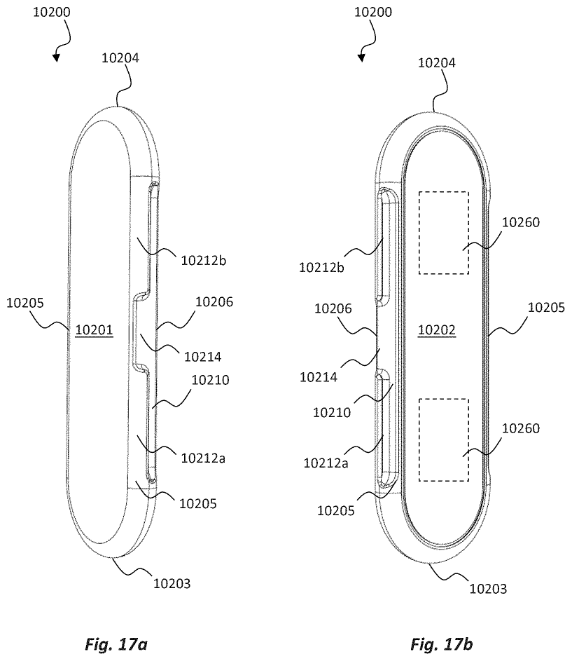

The base 10200 of the timer assembly 10100 is shown in more detail in FIGS. 17a and 17b and FIGS. 20a to 20c. The base 10200 in this embodiment has a substantially elongate, planar configuration with substantially flat front and rear surfaces 10201, 10202, curved first and second end surfaces 10203, 10204 and substantially straight first and second side surfaces 10205, 10206. The configuration of the end and side surfaces 10203-10206 provides the base 10200 with a substantially oblong profile. The length direction of the base 10200 extends between first and second end surfaces 10203, 10204, and the width direction of the base 10200 extends between the first and second side surfaces 10205, 10206. Each of the side surfaces 10205, 10206 has a respective groove 10210, 10211 that extends along a length of that side surface 10205, 10206. Front edges of the grooves 10210, 10211 are partially defined by raised regions 10212a, 10212b, 10213a, 10213b of the side surfaces 10205, 10206. The first side surface 10205 has a pair of the raised regions 10212a, 10212b separated by a gap 10214 at a central region of the first side surface 10205. Similarly, the second side surface 10206 has a pair of the raised regions 10213a, 10213b separated by a gap 10215 at a central region of the second side surface 10206.

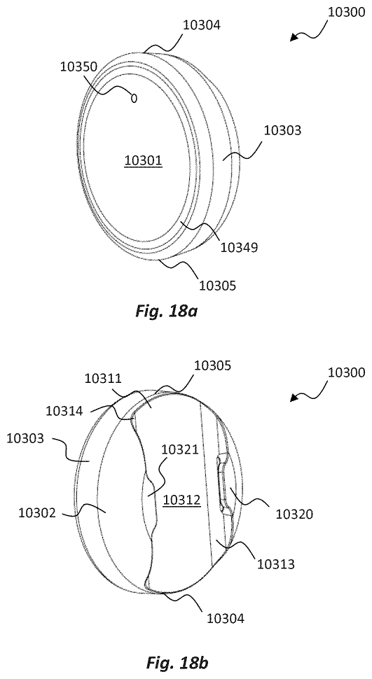

Referring to FIGS. 18a and 18b, the timer unit 10300 has a substantially disc-shaped configuration, with front and rear surfaces 10301, 10302 and a substantially circularly extending side surface 10303. As seen in FIG. 18b, the rear surface 10302 of the timer unit 10302 defines a channel 10311 that extends across a length of the timer unit 10300 between first and second ends 10304, 10305. The channel 10311 is defined by a bottom surface portion 10312 and opposing side surface portions 10313, 10314. In this embodiment, the rear surface 10302 of the timer unit 10300 also includes two tabs 10320, 10321 that extend partially over the channel 10311. Each tab 10320, 10321 overhangs a respective one of the side surface portions 10313, 10314.

Referring to FIGS. 16a and 16b, and FIGS. 19a to 20c, the timer unit 10300 is slidably mounted to the base 10200. The slidable mounting is achieved through insertion of the base 10200 into the channel 10311 of the timer unit 10300. Once the base 10200 is inserted into the channel 10311, the tabs 10320, 10321 of the timer unit 10300 can extend into and contact the grooves 10210, 10211 at the side surfaces of the base 10200, wherein the raised regions 10212a, 10212b, 10213a, 10213b, provide abutment surfaces for the tabs, preventing lifting of the timer unit from channel 10311, The grooves 10210, 10211 provide a track along which the tabs 10320, 10321 slide during sliding of the timer unit 10300 relative to the base 10200, the sliding providing for linear relative movement between the timer unit 10300 and the base 10200.

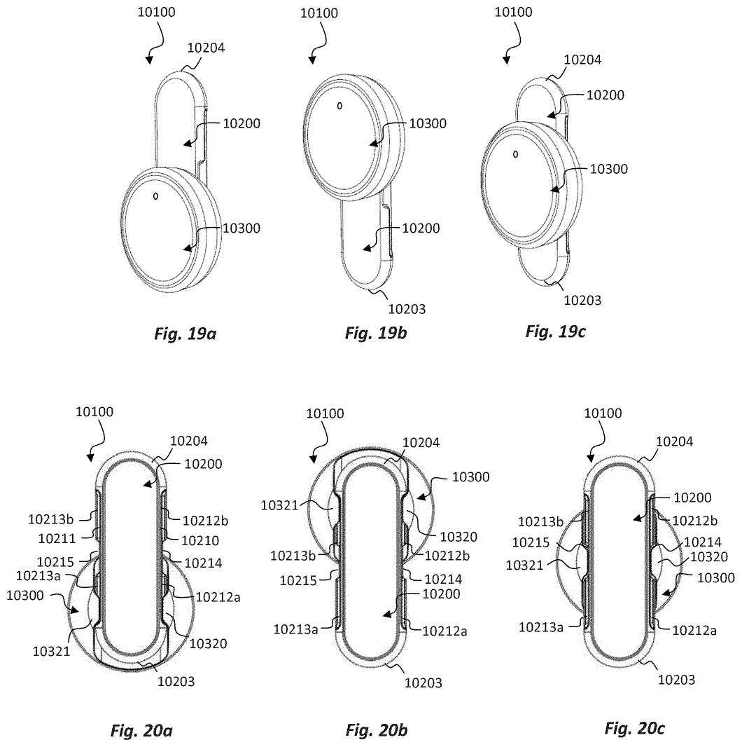

The above-described configuration enables the timer unit to move relative to the base, while remaining in contact with the base, between a first position as shown in FIGS. 19a and 20a and a second position as shown in FIGS. 19b and 20b. At the first position, the timer unit 10300 is positioned adjacent the first end 10203 of the base, At the second position, the timer unit 10300 is positioned adjacent the second end 10204 of the base, opposite to the first end of the base. As described in more detail below, movement of the timer unit 10200 to the second position initiates monitoring of the predetermined time period by the electronic timer of the timer unit 10300.

Thus, in this configuration, a user may conveniently initiate monitoring of the predetermined time period by simply sliding the timer unit relative to the base, whereupon the timer assembly will also provide a visual indication as to whether the monitoring has begun by the position of the timer unit. As a result of the simplicity, the user may be less likely to forget to initiate monitoring, which in turn may reduce a risk of the patient contracting a HAI for instance.

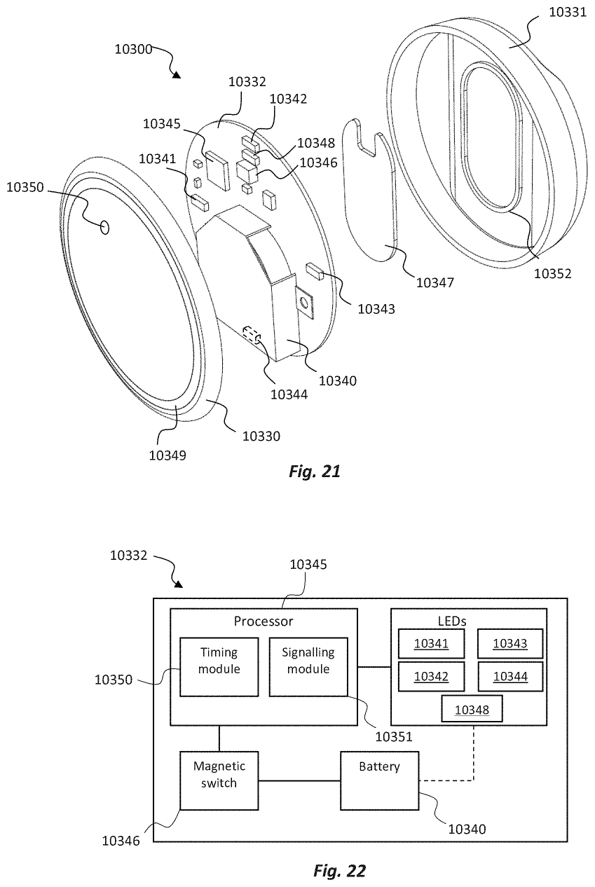

An exploded view of the timer unit is shown in FIG. 21. The timer unit includes a housing and in particular a casing having a front shell 10330 and a rear shell 10331, the front and rear shells 10330, 10331 being fixed together to define an internal chamber in which electrical components of the timer unit 10300 are located. The electronic components include a printed circuit board (PCB) 10332 on which a battery 10340 is mounted along with first, second, third, fourth and fifth LEDs 10341, 10342, 10343, 10344, 10348, a processor (microchip) 10345 and a magnetic switch 10346. The first, second, third and fourth LEDS 10341, 10342, 10343, 10344 are distributed around a periphery of the PCB 10332 and align with an annular window 10349 located at the periphery of the front surface 10301 of the timer unit 10300. The fifth LED 10348 aligns with a small circular window 10350 on the front surface 10301 of the timer unit 10300. The battery 10340 provides a source of power for the LEDs 10341, 10342, 10343, 10344, 10348 and the processor 10345. Additional LEDs may be provided to provide other information, such as a low battery level warning.

A schematic illustration of the electronic components is provided in FIG. 22, The electronic timer of the timer unit 10300 is provided at least in part by a timing module 10350 of the processor 10345, and is configured in this embodiment to initiating monitoring of the predetermined timer period when electricity is supplied to the processor 10345 from the battery 10340. The signalling apparatus of the timer unit is controlled by a signalling module 10351 of the processor 10345 and provided at least in part by the four LEDs 10341, 10342, 10343, 10344.

Electricity is provided to the processor 10345, and to the LEDS 10341, 10342, 10343, 10344, 10348, via an electrical circuit that includes the magnetic switch 10346, and specifically a reed switch. When the magnetic switch 10346 is in a closed (“on”) state, electricity can flow from the battery 10340 to the processor 10345, which initiates monitoring of the predetermined time period by the electronic timer, When the magnetic switch is in an open (“off”) state, electricity cannot flow from the battery 10340 to the processor 10345, preventing monitoring of the predetermined time period by the electronic timer. In this embodiment, the electronics are configured so that placement of the magnetic switch in the “off” state resets the monitoring of the predetermined time period. Thus, when the magnetic switch is transitioned from the “off” state to the “on” state, monitoring of the predetermined time period will always start from the beginning of the predetermined time period.

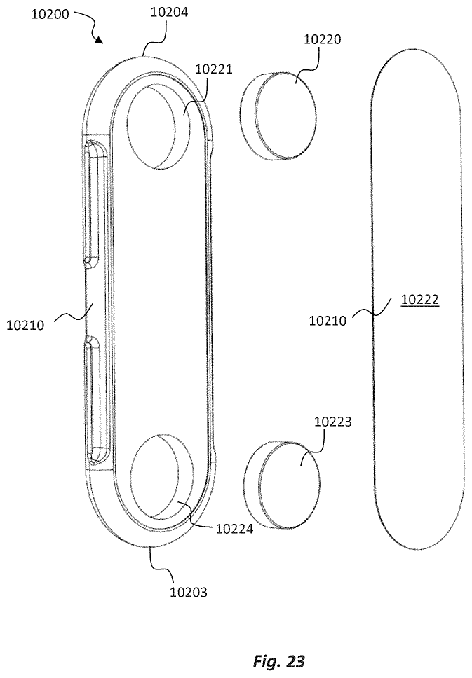

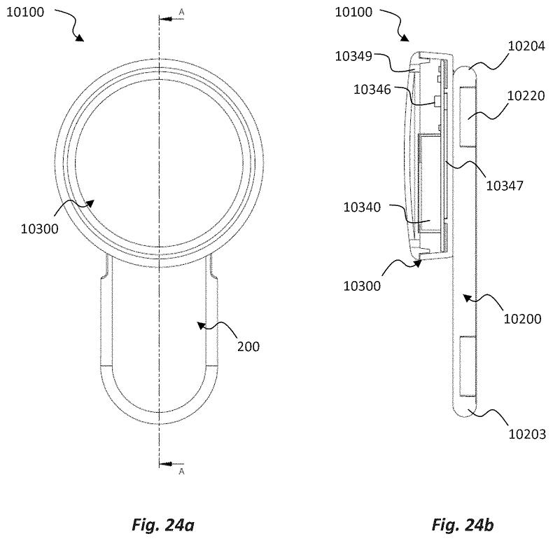

The magnetic switch 10346 is automatically transitioned to its “on” state when the timer unit 10300 is moved to the second position relative to the base 10200 (where it is positioned adjacent the second end 10204 of the base 10200). As seen in FIG. 23, the base 10200 includes a first magnet 10220 located in a recess 10221 adjacent the second end 10204 of the base, the recess 10221 and the first magnet 10220 being covered by a rear panel 10222. Therefore, when the timer unit 10300 is moved to the second position relative to the base 10200, the magnetic switch 10346 can be substantially aligned with the first magnet 10220, causing the switch 10346 to transition to the “on” state, initiating monitoring of the predetermined time period. Such alignment of the magnetic switch 10346 and the first magnet 10220 can be seen in FIG. 24b. Consequently, any movement of the timer unit 10300 from the second position towards the first position causes misalignment of the magnetic switch 10346 and the first magnet 10220, transitioning the switch 10346 to the “off” state.

Upon initiation of the monitoring of the predetermined time period, the signalling module 10351 causes the fifth LED 10348 to be lit to indicate that the time period is being monitored and the time period has not yet expired. The fifth LED 10348 can emit the light in a continuous or flashing mode and, in this embodiment, is configured to emit green light. After expiry of the time period as monitored by the timer, the signalling module 10351 switches off the fifth LED 10348 and switches on, in a repeating, sequential pattern, the first, second, third and fourth :LEDs 10341, 10342, 10343, 10344, thus providing an alert to the user that the predetermined time period has ended and that appropriate action needs to be taken. The repeating, sequential operation of the first, second, third and fourth LEDs 10341, 10342, 10343, 10344, which are visible via the annular window 10349, provides the user with a perception of a visible, ‘scrolling’ alert signal. In this embodiment, the first, second, third and fourth LEDs 10341, 10342, 10343, 10344 emit red light. Additional LEDs may be provided, e.g. 8 evenly-distributed LEDs, to provide a more continuous scrolling sensation.

To prevent inadvertent movement of the timer unit 10300 from either one of the first and second positions, the timer assembly 10100 is configured so that a moderate amount of force must be applied to move the timer unit 10300 between the first and second positions. Any inadvertent movement of the timer unit 10300 away from the first position or the second position could otherwise cause unintended initiation of monitoring of the predetermined time period or unintentional cessation of monitoring of the predetermined timer period. In this embodiment, a moderate force must be applied to the timer unit 10300, e.g. by hand, to overcome a magnetic attraction the releasably holds the tinier unit 10300 to the base at each of the first and second positions.

At the second position, the magnetic attraction takes place between the first magnet 10220 of the base 10200 and a second magnet 10347 that is provided in the timer unit 10300. As seen in FIG. 21, the second magnet 10347 is located adjacent the rear 10302 of the timer unit 10300, in a recess 10352 formed on an inner surface of the rear casing 10331.

At the first position, the magnetic attraction takes place between a third magnet 10223, provided in the base 10200, and the second magnet 10347 of the tinier unit 10300. As seen in FIG. 23, the third magnet 10223 is located in a recess 10224 adjacent the first end 10204 of the base, the recess 10224 and the third magnet 10223 being covered by the rear panel 10222. Notably, due to the positioning of the magnetic switch 10346 towards the second end 10304 of the timer unit 10300, when the timer unit 10300 is in the first position there is no alignment between the third magnet 10223 and the magnetic switch 10346.

In this embodiment, the timer unit 10300 is releasably mounted to the base 10200. The arrangement is such that the timer unit 10300 can be removed from the base 10200 and replaced with a different timer unit. Replacement of the tinier unit 10300 may be necessary if its battery has insufficient charge or if it is desired to monitor a different predetermined time period. In some embodiments, the timer assembly may be provided as a kit that includes a plurality of timer units. The time units may be configured to monitor different predetermined time periods, e.g. 24 hours, 48 hours, 72 hours, etc.

To remove the timer unit 10300 from the base 10200, the timer unit 10300 is movable to a third position relative to the base. In this embodiment, when the timer unit 10300 is in the third position, as illustrated in FIGS. 19c and 20c, it is located between the first and second positions, roughly halfway between the first and second ends 10203, 10204 of the base 10200. When the timer unit 10300 is located in the third position, the tabs 10320, 10321 of the timer unit 10300 no longer abut against the raised regions 10212a, 10212b, 10213a, 10213b of the side surfaces 10205, 10206 of the base 10200, and instead line up with the gaps 10214, 10215 in the side surfaces 10205, 10206. Since the gaps 10214, 10215 are larger than the tabs 10320, 10321, the tabs 10320, 10321 can pass through the gaps 10214, 10215 enabling removal of the timer unit 10300 from the base 10200.

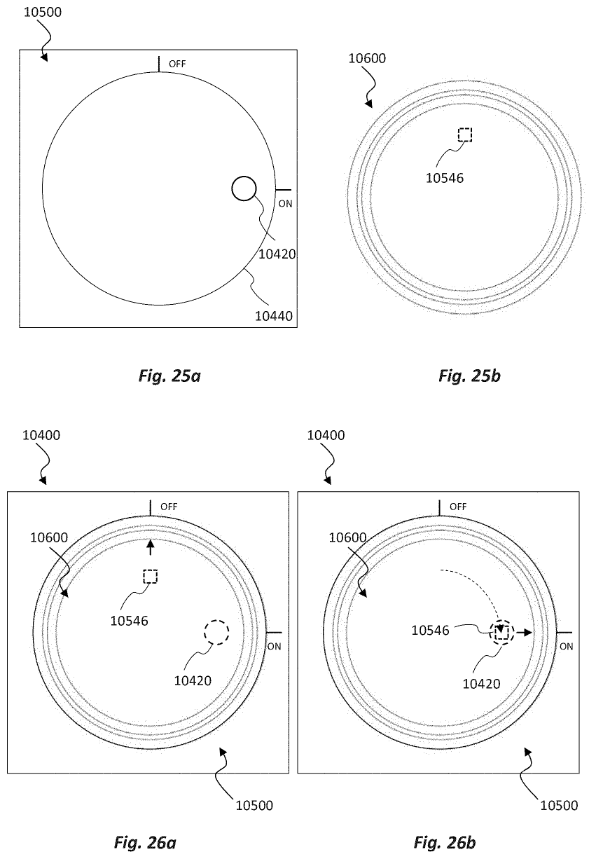

A base 10500 and a tinier unit 10600 of a timer assembly 10400 according to another embodiment of the present disclosure are illustrated in FIGS. 25a, 25b, 26a and 26b, respectively. In this embodiment, the tinier unit 10600 functions in a similar manner to the timer unit 10300 described above. However, the timer unit 10600 is configured to be rotatably mounted, rather than slidably mounted, to the base 10500. The base 10500 is a plate element having a circular, centrally located recess 10440 that is arranged to receive the timer unit 10600. The timer unit 10600 can be releasably held in the recess 10440 through magnetic interaction between magnets of the timer unit 10600 and the base 10500.

Following from this, the main difference between the timer assembly 10400 of the present embodiment and the timer assembly 10100 described above is the manner in which the timer unit 10600 is arranged to move between first and second positions of contact with the base 10500. In this embodiment, rather than there being linear movement of the timer unit 10600 between the first and second positions, the timer unit 10600 is arranged to rotate between the first and second positions. Again, the timer unit 10600 includes a magnetic switch 10546 and the base 10500 includes a first magnet 10520. When the timer unit 10600 is in the first position, as illustrated in FIG. 26a, the magnetic switch 10546 and the first magnet 10420 are misaligned and the magnetic switch 10546 is in the “off” state. When the timer unit 10600 is rotated to the second position as illustrated in FIG. 26b, e.g. by hand, the magnetic switch 10546 and the first magnet 10420 are aligned and the magnetic switch 10546 is in the “on” state, initiating monitoring of the predetermined time period.

In timer assemblies according to various preceding embodiments of the present disclosure, the monitoring of the predetermined time period is initiated by a user action related to a change in position of the timer unit relative to the base as discussed above. Monitoring of the predetermined time period may comprise counting up or counting down the predetermined time period using the timer.

The base can be fixed to a location that is easily accessible by a user and/or that provides a conspicuous location for observation or recognition by the user of the alert signal. In some embodiments, the base may include a fixing portion to fix the base to a support surface such as a surface of product in relation to which the predetermined time period is being monitored. For example, the base may be fixed to a portion of a cannula or endoscope. The fixing portion may include one or more adhesive pads 10260 positioned on the rear surface 10202 of the base 10200 as shown in FIG. 17b, for example. Additionally or alternatively, fixing portions that are used may include clips, screws, straps and/or hook and loop fasteners, for example.

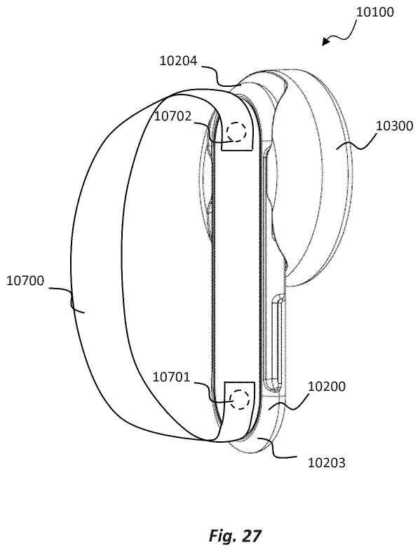

Referring to FIG. 27, the fixing portion may comprise a flexible strap 10700 that extends from one or both ends 10203. 10204 of the base 10200. The flexible strap 10700 may form a loop that can extend around a tube, pipe, endoscope or other item to fix the timer assembly to that item. At least one end of the flexible strap 10700 may comprise a magnet 10701, 10702 that is attracted to one or more magnets 10220, 10223 located in the base 10200 as described above or to one or more further magnets in the base 10200. In some instances, the flexible strap 10700 may be passed over the front surface of the base in a manner that obstructs movement of the timer unit 10300 between the first and second positions, preventing inadvertent initiation or cessation of the monitoring of the predetermined time period. The strap may also, therefore, provide a form of locking mechanism for the timer assembly.

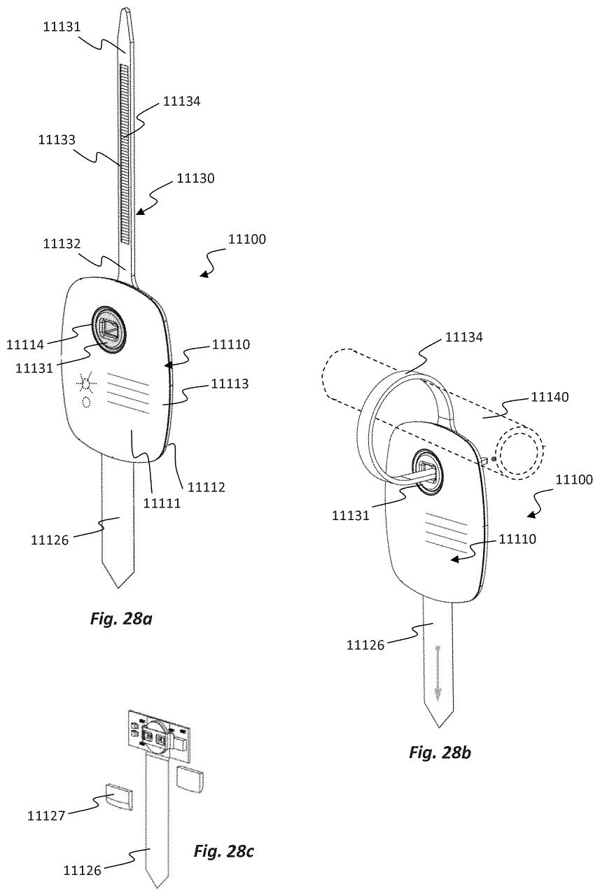

A label assembly 11100 according to an embodiment of the present disclosure is illustrated in FIGS. 28a and 28b. The label assembly 11100 is generally configured in the of a label tag that may be mounted to an article 11140, e.g. by being secured around and/or hung from the article.

The label assembly 11100 of FIG. 28a includes a body 11110 having a first face 11111 and a second face 11112. The first and second faces 11111, 11112 are located at opposite sides of the body 11110 and are connected together by side edges 11113. The first face 11111 and second face 11112 may provide two major outer surfaces of the body 11110. In this embodiment, the first and second faces 11111, 11112 are flat and the side edges 11113 are curved. In general, the body 11110 is a relatively flat component with the majority of its outer surface provided by the first and second faces 11111, 11112.

The label assembly 11100 includes a timer to monitor a predetermined time period and signalling apparatus to provide an alert signal on expiry of the predetermined time period, substantially in accordance with previous embodiments. In this regard, the label body 11110 may house an electronics unit e.g. of a type as described above with reference to FIG. 3.

Information relating to the time period that is monitored and/or the article relating to the time period may be printed and/or written on the first and/or second face of the body 11110.

The body 11110 defines a through-hole 11114, extending between the first face 11111 and the second face 11112 of the body.

The label assembly 11100 includes a mounting mechanism for mounting the label assembly 11100 to an article. The mounting mechanism includes a locking portion 11114 and an elongate portion 11130. The elongate portion 11130 has a first end 11131, a second end 11132 and a central region 11133 between the first and second ends 11131, 11132.

In this embodiment, the locking portion 11114 is provided in the through-hole 11131 of the body 11110 of the label assembly 11110. The first end 11131 and optionally also the central region 11133 of the elongate portion 11130 may be extended through the through-hole 11131 wherein the locking portion 1114 lockingly engages the elongate portion 11130, securing the elongate portion 11130 in a closed loop configuration.

In this embodiment, the elongate portion 11130 has one or more first teeth 11134 located at the first end 11131 and/or central region 11133 of the elongate portion 11130. The locking portion 11114 is configured to engage the first teeth to lockingly engage the elongate portion 11130. For example, the locking portion 11114 may comprise one or more second teeth that lockingly engage the first teeth. The locking portion may comprise a pawl comprising the one or more second teeth adapted to lockingly engage the first teeth. The mounting mechanism may therefore function in a similar manner to a cable tie.

By forming a closed loop, the elongate portion 111130 may be used to mount the assembly 11100 to an article, e.g. by hanging it from the article. While interlocking teeth/a pawl and tooth mechanism are described above to secure the closed loop, in alternative embodiments different locking features may be used to secure the closed loop.

As illustrated in FIGS. 28a and 28b, the through-hole 11131 may be located at a relatively central region of the label assembly 11100 where the assembly may be relatively strong and relatively protected from damage, e.g. in comparison to a periphery or side edges 11113 of the label body 11110. Nevertheless, in alternative embodiments, the through-hole 11131 may be provided elsewhere, e.g. in an extension of the label body 11110.

In accordance with previous embodiments, the label assembly 11100 includes an actuator 11126 that is removable, e.g. through an opening, to initiate monitoring of the time period. In this embodiment, the actuator is provided by a release element (tab 11126). The label assembly 11100 includes a sealing mechanism 11127 (see FIG. 28c), such as opposing resiliently flexible sealing or gasket elements 11127 held within the electronics unit housing, either side of the tab 11126 adjacent the opening, to seal the associated opening after removal of the release element 11126. This allows the label assembly 11100 to maintain a sealed configuration during use, protecting the electrical components of the device 11100 from contamination as a result of ingress of contaminants. When the label assembly 11100 is for medical use, the sealing mechanism may prevent body fluids entering the timer device. Such a sealing mechanism may be employed in other embodiments described herein, particularly where a removable actuator tab is employed.

The label assembly 11100 may provide a form of timing device or timing label, including a signalling apparatus, with an integrated cable tie. Additionally or alternatively, the label assembly 11100 may provide a security tag, security seal or cable tie tag with an integrated timing device and signalling apparatus.

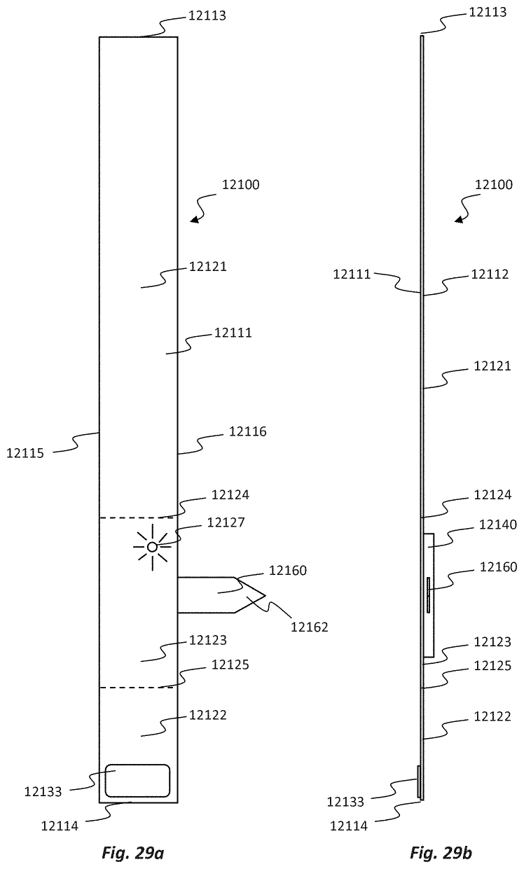

Front and side views of a label 12100 according to another embodiment of the present disclosure are shown in FIGS. 29a and 29b. Like preceding embodiments, the label 12100 includes a timer to monitor a predetermined time period and a signalling apparatus that provides an alert signal on expiry of the predetermined time period.

The label 12100 has a substantially planar configuration, with substantially rectangular front and rear surfaces 12111, 12112, a first end edge 12113, a second end edge 12114, a first side edge 12115 and a second side edge 12116. The length direction of the label 12100 extends between the first and second end edges 12113, 12114 and the width direction of the label 12100 extends between the first and second side edges 12115, 12116.

In the length direction of the label 12100, the label 12100 includes a first label portion 12121, a second label portion 12122 and a third label portion 12123, the first label portion 12121 being located towards the first end 12113 of the label 12100, the second label portion 12122 being located towards the second end 12114 of the label 12100 and the third label portion 12123 being located between the first and second label portions 12121, 12122.

The first and second label portions 12121, 12122 are fixable together so that the label forms a closed loop. In this embodiment, at least one of the first and second label portions 12121, 12122 comprises a layer of adhesive 12133 covered by a releasable backing layer. The backing layer is releasable, e.g. by peeling, to expose the adhesive layer 12133.

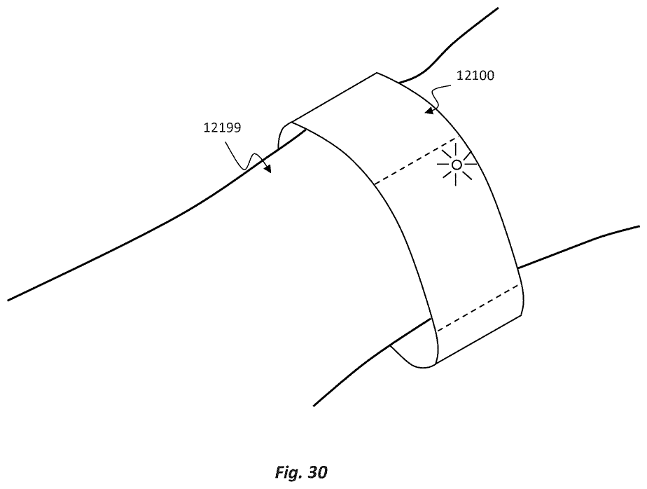

The first and second label portions 12111, 12112 are configured to be permanently fixed together so that release of the closed loop may not be perthrmed without permanently damaging the label 12100. In general, the label 12100 is configured to take the form of a band or other generally ring-shaped item that can extend around a support surface or article. While the article may be a product such as a medical device, container or otherwise, in some embodiments, as shown in FIG. 30, it may be a body part such as a wrist 12199. In this regard the label 12100 may be a wearable device such as a wristband, leg band or similar, Thus, the label may be a wristband and the first, second and third label portions may be considered first, second and third wristband portions.

In this embodiment, the label is 12100 formed in part from a one-piece sheet of material that extends across the entire label 12100 between the end and side edges 12113, 12114, 12115, 12116. The one-piece sheet of material may be a plastic or paper material. For example, the one-piece sheet of material may comprise high-density polyethylene fibres, and may be a flashspun material, for example.

The label 12100 is substantially flat, except at a region where it includes a housing 12140, an electronics unit being located in the housing 12140. The housing 12140 and the electronics unit are formed in a similar or identical manner to the housing 1140 and electronics unit 1150 described above with reference to FIGS. 2a to 4. The electronics unit again comprises the timer to monitor the predetermined time period and the signalling apparatus that provides an alert signal on expiry of the predetermined time period. In this embodiment, the alert signal is provided by one or more LEDs that are visible through a window 12127 at the front surface of the third label portion 12123.

The label 12100 includes an actuator to initiate the monitoring of the predetermined time period by the timer. In this embodiment, the actuator is provided by a tab 12160. The tab 12160 has a proximal end that extends into the housing 12140 to interact with components of the electronics unit within the housing 12140 and an opposite distal end 12162 that is engageable by the user to pull the tab 12160 from the housing 12140. Pulling the tab 12160 can initiate the monitoring of the predetermined time period by allowing completion of an electrical circuit in the electronics unit in a similar manner to that described above with reference to the electronics unit 1150 of FIG. 3. A sealing mechanism may be employed adjacent an opening in the housing 12140 through which the tab 12160 is pulled, e.g. substantially as described above with reference to FIG. 28c.

In this embodiment, a first line of perforations 12124 extends between the first and second side edges 12115, 12116 of the label 12100 in the width direction of the label 12100, directly between the first and third label portions 12121, 12123, and a second line of perforations 12125 extends between the first and second side edges 12115, 12116 of the label 12100 in the width direction of the label 12100, directly between the second and third label portions 12122, 12123. The lines of perforations 12124, 12125 are provided in the one-piece sheet of material that extends across the label 12100 between the end and side edges 12113, 12114, 12115, 12116. The third label portion 12121 is therefore separable from the first and second label portion 12121, 12122 by a user tearing along the first and second lines of perforations 12124, 12125. The releasable connection between the third label portion 12123 and the first and/or second label portions 12121, 12122 may allow the closed loop to be opened without requiring release of the first label portion 12121 from the second portion 12122. The release of the connection between the third label portion 12123 and the first and/or second label portions 12121, 12122 may enable dismounting of the label 12100 from the support surface or article (e.g. from the wrist 12199 or otherwise). The release of the connection between the third label portion 12123 and the first and/or second label portions 12121, 12122 may be irreversible. For example, release by tearing of perforations or otherwise may permanently damage the label 12100, preventing re-use of the label 12100. Moreover, providing the option of removing the third label portion 12123 from the first and/or second label portions 12121, 12122 can also assist with waste disposal or recycling practices as described above.

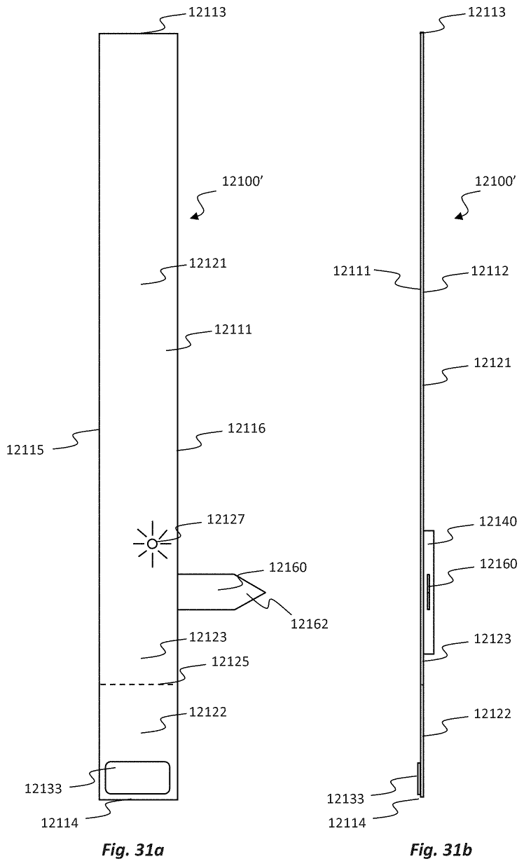

In an alternative embodiment, as illustrated in FIGS. 31a and 31b, a label 12100′ is provided that is otherwise identical to the label 12100 described above with reference to FIGS. 29a to 30, but which has only one line of perforations 12125, to allow the closed loop to be opened without requiring release of the first label portion 12121 from the second label portion 12122. In this embodiment the line of perforations 12125 is located between the second label portion 12122 and the third label portion 12123, although alternatively it might be located between the first label portion 12121 and the third label portion 12123.

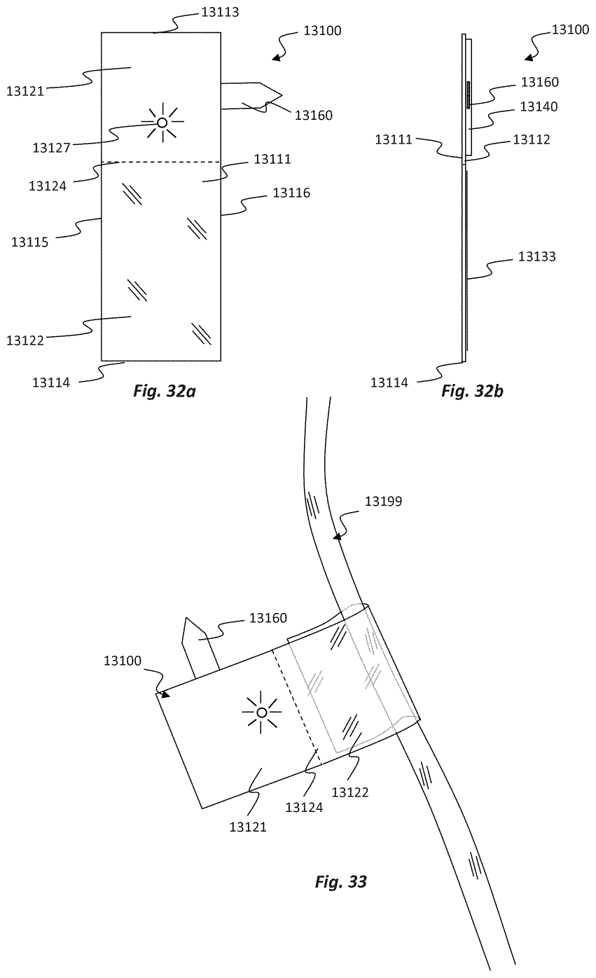

Front and side views of a label 13100 according to another embodiment of the present disclosure are shown in FIGS. 32a and 32b. Like preceding embodiments, the label 13100 includes a timer to monitor a predetermined time period and a signalling apparatus that provides an alert signal on expiry of the predetermined time period.

The label 13100 has a substantially planar configuration, with substantially rectangular front and rear surfaces 13111, 13112, a first end edge 13113, a second end edge 13114, a first side edge 13115 and a second side edge 13116. The length direction of the label 13100 extends between the first and second end edges 13113, 13114 and the width direction of the label 13100 extends between the first and second side edges 13115, 13116.

In the length direction of the label 13111, the label 13100 includes a first label portion 13121 and a second label portion 13122, the first label portion 13121 being located towards the first end 13113 of the label 13100 and the second label 13122 portion being located towards the second end 13114 of the label 13100.

The second label portion 13122 provides a fixing portion of the label to fix the label to a support such as a transparent IV tube 13199 as illustrated in FIG. 33. The fixing portion 13122 is configured to fix the label 13100 to the support 13199 by extending around the support and fixing to the support 13199, fixing to itself and/or fixing to another surface of the label 13100 (e.g. by folding). In this embodiment, the fixing portion 13122 comprises a layer of adhesive 13133 covered by a releasable backing layer. The backing layer is releasable, e.g. by peeling, to expose the adhesive layer 13133.

The second/fixing portion of the label 13122 includes base layer of material that is that partially transparent, the layer of adhesive coating the base layer. The base layer and adhesive layer are both at least partially transparent or translucent. The transparency or translucency in the base layer may be provided through use of transparent or translucent polymer in the base layer, for example, and transparent or translucency in the adhesive may be provided through use of a clear adhesive

In general, the fixing portion 13122 of the label 13100 is at least partially transparent or translucent such that, when the label 13100 is fixed to the support 13199, the support 13199 is at least partially visible through the fixing portion.

By providing for at least partial visibility of the support 13199 through the fixing portion 13122, it may be possible to view more of the support 13199 than would otherwise be possible. For example, where the support 13199 is a transparent IV tube as shown in FIG. 33, it may be possible to check substantially the entire IV tube for patency. In simple terms, this means checking that the line is open and not blocked. By providing for at least partial visibility of the support 13199 through the fixing portion, it may be possible to check that a blockage is not present in the IV tube at the particular position where the label 13100 is fixed. Nevertheless, use of a the label 13100 having a transparent or translucent fixing portion is not limited to use with IV tubes only. The label 13100 may be used in a variety of situations where it is desirable to reduce obscuring of an underlying label support.

In contrast to the second/fixing 13122 portion of the label 13100, the first label portion 13121 of the label 13100 may or may not comprise transparent or translucent material

In this embodiment, the label 13100 is substantially flat, except at a region where it includes a housing 13140, an electronics unit being located in the housing 13140. The housing 13140 and the electronics unit are formed in a similar or identical manner to the housing 1140 and electronics unit 1150 described above with reference to FIGS. 2a to 4. The electronics unit again comprises the timer to monitor the predetermined time period and the signalling apparatus that provides an alert signal on expiry of the predetermined time period. In this embodiment, the alert signal is provided by one or more LEDs that are visible through a window 13127 at the front surface of the first label portion 13121.

The label 13100 includes an actuator to initiate the monitoring of the predetermined time period by the timer. In this embodiment, the actuator is provided by a tab 13160. The tab 13160 has a proximal end that extends into the housing 13140 to interact with components of the electronics unit within the housing 13140 and an opposite distal end 13162 that is engageable by the user to pull the tab 13160 from the housing 13140. Pulling the tab 13160 can initiate the monitoring of the predetermined time period by allowing completion of an electrical circuit in the electronics unit in a similar manner to that described above with reference to the electronics unit 1150 of FIG. 3. A sealing mechanism may be employed adjacent an opening in the housing 13140 through which the tab 13160 is pulled, e.g. substantially as described above with reference to FIG. 28c.

In this embodiment, a line of perforations 13124 extends between the first and second side edges 13115, 13116 of the label 13100 in the width direction of the label 13100, directly between the first and second label portions 13121, 13122. The second label portion (fixing portion) 13122 is therefore separable from the first label portion 13121 by a user tearing along the lines of perforations 13124. The releasable connection between the first and second label portions 13121, 13122 can allow the first portion 13121 to be removed or disconnected from a support surface to which the label is fixed (e.g. IV tube 13199 or otherwise) while the second portion 13122 remains fixed to that support surface. Moreover, providing the option of removing the second label portion 13122 from the first label portion 13121 can also assist with waste disposal or recycling practices as described above.

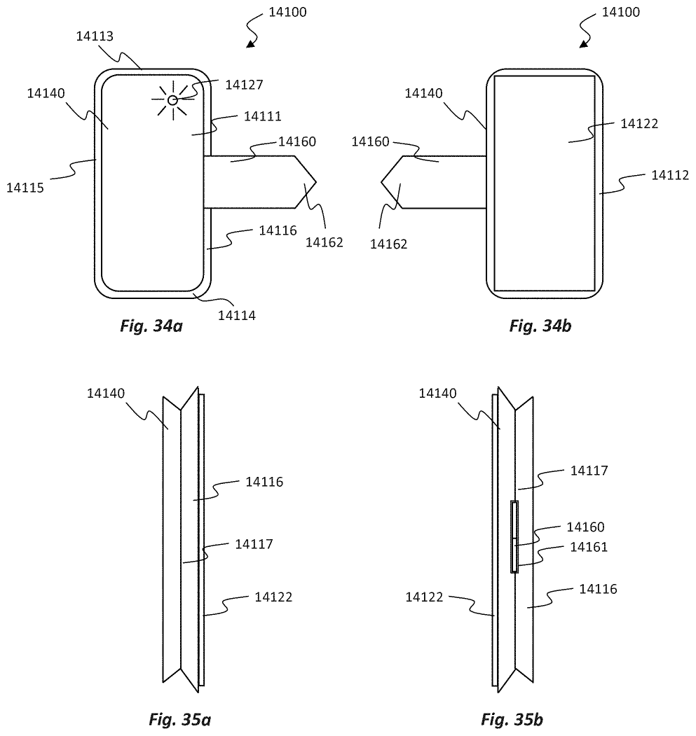

Front, rear and side views of a label 14100 according to another embodiment of the present disclosure are shown in FIGS. 34a to 35b. Like preceding embodiments, the label 14100 includes a timer to monitor a predetermined time period and a signalling apparatus that provides an alert signal on expiry of the predetermined time period.

The label 14100 includes a housing 14140 comprising opposing front and rear surfaces 14111, 14112, and a plurality of sides surfaces that extend between the front and rear surfaces and define a peripheral edge of the housing. The side surfaces include a first end surface 14113, a second end surface 14114, a first side surface 14115 and a second side surface 14116. An electronics unit is located in the housing 14140, the electronics unit being formed in a similar or identical manner to the electronics unit 1150 described above with reference to FIGS. 2a to 4. The electronics unit again comprises the timer to monitor the predetermined time period and the signalling apparatus that provides an alert signal on expiry of the predetermined time period, in this embodiment, the alert signal is provided by one or more LEDs that are visible through a window 14127 at the front surface of the housing 14100.

The label 14100 includes a fixing portion 14122 that is configured to fix the label 14100 to a support surface. In this embodiment, the fixing portion 14122 comprises a layer of adhesive located over the rear surface 14112 of the label 14100, the adhesive layer being covered by a releasable backing layer. The backing layer is releasable, e.g. by peeling, to expose the adhesive layer.

The housing 14140 of the label 14100 includes a groove 14117 that extends around the entire peripheral edge of the housing 14140. The groove 14117 provides for a finger grip, allowing a user to grasp the label 14100 using their fingers, e.g. in order to manipulate the label 14100 when fixing the label 14100 to a support surface or when removing the label 14100 from a support surface. In alterative embodiments, the groove may extend only partially around the peripheral edge of the housing. For example, the groove may be located at least partially along the first side surface 14115 and the second side surface 14116 only.

The label 14100 includes an actuator to initiate the monitoring of the predetermined time period by the timer. In this embodiment, the actuator is provided by a tab 14160. The tab 14160 has a proximal end that extends into the housing 14140, via a slot 14161 in the housing 14140, to interact with components of the electronics unit within the housing 14140. An opposite distal end 14162 of the tab 14160 is engageable by the user to pull the tab 14160 from the housing 14140. Pulling the tab 14160 can initiate the monitoring of the predetermined time period by allowing completion of an electrical circuit in the electronics unit in a similar manner to that described above with reference to the electronics unit 1150 of FIG. 3. In this embodiment, the slot 14161 is positioned in the groove 14117, and substantially the most recessed point of the groove 14117. Accordingly, the slot 14161 is located in a generally recessed position on the outer surface of the housing 14140. This provides for protection of the slot 14161 and reduces the likelihood of damage of the slot 14161 or ingress of contaminants through the slot 14161 into the housing 14160. A sealing mechanism may be employed adjacent the slot 14161 in the housing 14140 through which the tab 14160 is pulled, e.g. substantially as described above with reference to FIG. 28c.

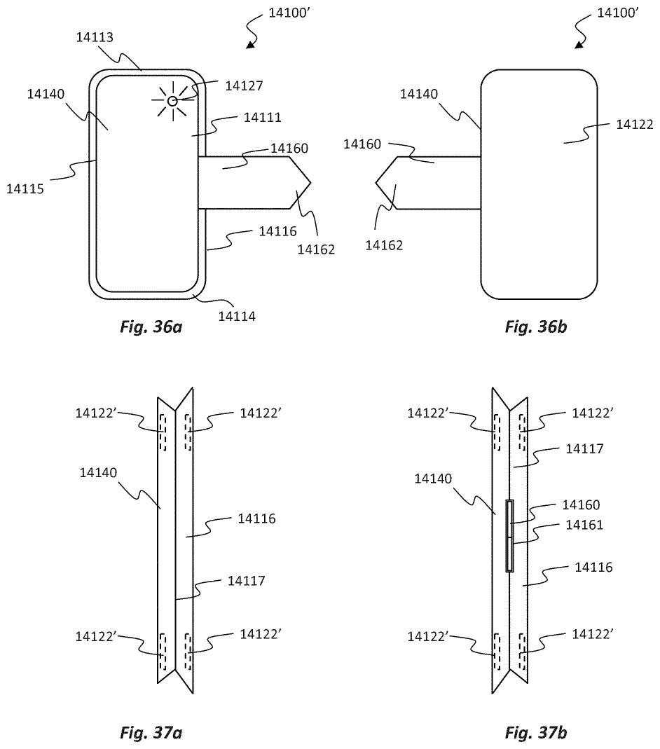

Front, rear and side views of a label 14100′ according to another embodiment of the present disclosure are shown in FIGS. 36a to 37b. The label 14100′ is substantially identical to the label 14100 described above with reference to FIGS. 34a to 35b, except that it employs one or more magnets 14122′, instead of an adhesive layer, to fix the label 14140′ to a support surface. The magnets 14122′ are positioned in or on the housing 14140 such that either one of the front surface 14111 or the rear surface 14122 of the housing may be selectively fixed magnetically to a support surface. In either orientation, the groove 14117 remains accessible to a user in order to manipulate the label 14100 when fixing the label 14100′ to the support surface or when removing the label 14100′ from the support surface.

It will be appreciated by persons skilled in the art that numerous variations and/or modifications may be made to the above-described embodiments, without departing from the broad general scope of the present disclosure. Aspects from an embodiment of a label assembly may be combined with an embodiment of a label and/or an embodiment of a timer assembly while remaining within the broad general scope of the present disclosure of timer devices. For example, while monitoring of a common predetermined time period is described in some embodiments of the label assemblies, in alternative arrangements, different predetermined time periods may be monitored by the first and second labels, respectively.

Nevertheless, the initiating of monitoring of the different predetermined time periods may occur at the same time. The present embodiments are, therefore, to be considered in all respects as illustrative and not restrictive.

The following are numbered, non-limiting examples of features of the present disclosure, in accordance with one or more aspects and/or embodiments described above.

### EXAMPLE 1

A label assembly comprising at least first and second labels, wherein:
the first label comprises:
   a first timer to monitor a predetermined time period; and
   a first signalling apparatus that provides an alert signal on expiry of the predetermined time period; and
the second label comprises:
   a second tinier to monitor the predetermined time period; and
   a second signalling apparatus that provides an alert signal on expiry of the predetermined time period;

the first and second labels are releasably connected to each other; and
the first and second timers are configured to monitor the predetermined time period at the same time.

### EXAMPLE 2

The label assembly of Example 1, wherein the label assembly comprises at least one actuator to initiate monitoring of the predetermined time period by the first and second timers at the same time.

### EXAMPLE 3

The label assembly of Example 2, wherein the at least one actuator comprises at least one tab that is released to initiate the monitoring of the predetermined time period.

### EXAMPLE 4

The label assembly of Example 3, wherein at least one of the first or second labels comprises a releasable backing layer that is connected to the at least one tab, wherein removal of the backing layer causes the release of the tab to initiate the monitoring.

### EXAMPLE 5

The label assembly of Example 3, wherein the at least one tab comprises a distal end or region that is engageable by a user's fingers to release the tab.

### EXAMPLE 6

The label assembly of any one of Examples 3, 4 or 5, wherein a part of the a least one tab is interposed between electrical components of the first and/or second label.

### EXAMPLE 7

The label assembly of Example 6, wherein the interposing between electrical components prevents a supply of electricity to the first and/or second timer until the tab is released.

### EXAMPLE 8

The label assembly of any one of Examples 2 to 7, wherein the at least one actuator is a common actuator that initiates monitoring of the predetermined time period by both the first and second timers.

### EXAMPLE 9

The label assembly of Example 8, wherein the common actuator extends between the first and second labels.

### EXAMPLE 10

The label assembly of Example 8 or 9 wherein the common actuator comprises a tab, the tab having a first proximal end interposed between electrical components of the first timer and a second proximal end interposed between electrical components of the second timer.

### EXAMPLE 11

The label assembly of Example 10, wherein the tab comprises a third, distal end that is engageable by a user's fingers to cause release of both the first end of the tab from the electrical components of the first label and the second end of the tab from the electrical components of the second label.

### EXAMPLE 12

The label assembly of any one of the preceding Examples, wherein the monitoring of the predetermined time period by the first and/or second timers is initiated by disconnecting the releasable connection between the first label and the second label.

### EXAMPLE 13

The label assembly of any one of the preceding Examples wherein the first and second labels are releasably connected to each other by a connection that comprise a frangible element, tear line, tear notch, perforations and/or other region of weakness that enables manual separation of the first portion from the second portion.

### EXAMPLE 14

The label assembly of any one of the preceding Examples wherein the connection between the first and second labels comprises a first line of perforations.

### EXAMPLE 15

The label assembly of any one of the preceding Examples wherein the first and second labels are located side by side and the connection between the first and second labels extends between adjacent side edges of the first and second labels.

### EXAMPLE 16

The label assembly of any one of Examples 1 to 14, wherein the first and second labels are located one on top of the other.

### EXAMPLE 17

The label assembly of any one of the preceding Examples comprising the first label, the second label and no additional labels.

### EXAMPLE 18

The label assembly of any one of the preceding Examples wherein at least one of the first or second labels comprises first and second portions that are releasably connected to each other.

### EXAMPLE 19

The label assembly of Example 18, wherein the first portion is located towards a first end of the label and the second portion is located towards a second end of the label, opposite from the first end, along a longitudinal axis of the label.

### EXAMPLE 20

The label assembly of Example 18 or 19, wherein the first and second portions are releasably connected to each other by a connection that comprise a frangible element, tear line, tear notch, perforations and/or other region of weakness that enables manual separation of the first portion from the second portion.

### EXAMPLE 21

The label assembly of Example 18 wherein the connection between the first and second portions comprises a second line of perforations.

### EXAMPLE 22

The label assembly of Example 18, wherein the releasable connection between the first and second portions is stronger than the releasable connection between the first and second labels.

### EXAMPLE 23

The label assembly of Example 18, wherein the first and second labels are releasably connected to each other by a connection that comprise a first line of perforations and the first and second portions are releasably connected to each other by a connection that comprises a second line of perforations, wherein the second line of perforations is stronger than the first line of perforations.

### EXAMPLE 24

the label assembly of Example 23, wherein the second line of perforations comprises perforations that are distributed less frequently and/or that are smaller than perforations of the first line of perforations.

### EXAMPLE 25

The label assembly of any one of the preceding Examples, wherein at least one f the first or second labels comprises a fixing portion to fix the label to a support surface.

### EXAMPLE 26

The label assembly of Example 25, wherein the fixing portion comprises adhesive.

### EXAMPLE 27

The label assembly of Example 25 or 26, wherein the first label comprise the fixing portion and the second label is absent of any fixing portion.

### EXAMPLE 28

The label assembly of any one of the preceding Examples wherein the first label comprises a first power source to power the first timer and the first signalling apparatus and the second label comprises a second power source to power the second timer and the second signalling apparatus.

### EXAMPLE 29

The label assembly of any one of the preceding Examples, wherein at least one of the first or second signalling apparatuses is configured to provide one or more alert signals in the lead up to expiry of the predetermined time period.

### EXAMPLE 30

The label assembly of Example 29, wherein at least one of the first or second signalling apparatuses is configured to provide different alert signals for different portions of time in the lead up to expiry of the predetermined time period.

### EXAMPLE 31

The label assembly of Example 29, wherein at least one of the first or second signalling apparatuses is configured to provide a first type of alert signal prior to expiry of the predetermined time period and a second type of alert signal on expiry of the predetermined time period.

### EXAMPLE 32

The label assembly of Example 29, wherein at least one of the first or second signalling apparatuses is configured to provide a first type of alert signal during a first time portion following initiation of monitoring of the predetermined time period, a second type of alert signal during a second time portion that follows the first time portion and is prior to expiry of the predetermined time period, and a third type of alert signal on expiry of the predetermined time period.

### EXAMPLE 33

The label assembly of Example 31 or 32, wherein the different types of alert signals are light signals of different colours or different combinations of colours.

### EXAMPLE 34

The label assembly of any one of the preceding Examples wherein at least one of the first or second signal apparatuses comprises at least one LED to provide the alert signal.

### EXAMPLE 35

The label assembly of any one of the preceding Examples, wherein the label assembly is a shipping label assembly.

### EXAMPLE 36

A label comprising:
a first label portion, a second label portion and a third label portion, the third label portion being connected to, and located between, the first and second label portions;
wherein the third label portion comprises a timer to monitor a predetermined time period and a signalling apparatus that provides an alert signal on expiry of the predetermined time period; and
wherein the first label portion comprises a first fixing portion to fix the label to a support surface and the second label portion comprises a second fixing portion to fix the label to the support surface.

### EXAMPLE 37

The label of Example 36 wherein the third label portion does not comprise any fixing portion to fix the label to the support surface.

### EXAMPLE 38

The label of Example 36 or 37, wherein the first fixing portion comprises adhesive and/or the second fixing portion comprises adhesive.

### EXAMPLE 39

The label of Example 38, wherein the first fixing portion comprises a first adhesive layer and a first backing layer releasably covering the first adhesive layer and/or the second fixing portion comprises a second adhesive layer and a second backing layer releasably covering the second adhesive layer

### EXAMPLE 40

The label of any one of Examples 36 to 39, wherein the first label portion is located towards a first end of the label and the second label portion is located towards a second end of the label, opposite from the first end along a longitudinal axis of the label, the third label portion being located between the first and second label portions along the longitudinal axis.

### EXAMPLE 41

The label of any one of Examples 36 to 40, wherein the third label portion is releasably connected to the first and second label portions.

### EXAMPLE 42

The label of any one of Examples 36 to 41, comprising a first releasable connection between the first label portion and the third label portion and a second releasable connection between the second label portion and the third label portion.

### EXAMPLE 43

The label of Example 42 wherein each releasable connection comprises a frangible element, tear line, tear notch, perforations and/or other region of weakness.

### EXAMPLE 44

The label of any one of Examples 36 to 43, wherein, the third label portion is removable from the label when the first and second fixing portions are fixing the label to a support surface.

### EXAMPLE 45

The label of any one of Examples 36 to 44, wherein the third label portion comprises a power source to power the timer and the signalling apparatus.

### EXAMPLE 46

The label of Example 45, wherein the power source, the signalling apparatus and the timer are comprised in an electronics unit.

### EXAMPLE 47

The label of any one of Examples 36 to 46, wherein the third label portion comprises a housing in which at least the timer and the signalling apparatus are located.

### EXAMPLE 48

The label of any one of Examples 36 to 47, wherein the signalling apparatus is configured to provide one or more alert signals in the lead up to expiry of the predetermined time period.

### EXAMPLE 49

The label of Example 48, wherein the signalling apparatus is configured to provide a first type of alert signal prior to expiry of the predetermined time period, and a second type of alert signal on expiry of the predetermined time period.

### EXAMPLE 50

The label of Example 49, wherein the different types of alert signals are light signals of different colours or different combinations of colours.

### EXAMPLE 51

The label of any one of Examples 36 to 50, comprising an actuator to initiate monitoring of the predetermined time period by the timer.

### EXAMPLE 52

The label of Example 51, wherein the actuator comprises a tab that is released to initiate the monitoring of the predetermined time period.

### EXAMPLE 53

The label of Example 52 wherein the label comprises an opening at a front of the label through which the tab extends for engagement by a user.

### EXAMPLE 54

The label of any one of Examples 36 to 53, wherein the label is a shipping label.

### EXAMPLE 55

A timer assembly comprising:
a base; and
a timer unit, the timer unit comprising:
   an electronic timer to monitor a predetermined time period; and
a signalling apparatus that provides an alert signal on expiry of the predetermined time period;
wherein the timer unit is movable relative to the base between at least a first position of contact with the base and a second position of contact with the base, wherein movement of the tuner unit to the second position initiates monitoring of the predetermined time period by the electronic timer.

### EXAMPLE 56

The timer assembly of Example 55, wherein movement of the timer unit to the first position turns off monitoring of the predetermined time period by the electronic timer.

### EXAMPLE 57

The timer assembly of Example 55 or 56, wherein the timer unit is movably mounted to the base.

### EXAMPLE 58

The timer assembly of Example 55, 56 or 57, wherein the movement between the first and second positions comprises linear movement.

### EXAMPLE 59

The timer assembly of Example 57 or 58, wherein the timer unit is slidably mounted to the base.

### EXAMPLE 60

### The timer assembly of Example 59, wherein the base comprises a track on which the timer unit is slidably mounted.

### EXAMPLE 61

The timer assembly of Example 55, 56 or 57 wherein the movement between the first and second positions comprises rotational movement.

### EXAMPLE 62

The timer assembly of Example 55 or 61, wherein the timer unit is rotatably mounted to the base.

### EXAMPLE 63

The timer assembly of any one of Examples 55 to 62, wherein the timer unit comprises a switch that is activated initiate monitoring of the predetermined time period when the timer unit is moved to the second position.

### EXAMPLE 64

The timer assembly of Example 63, wherein the switch is a proximity switch.

### EXAMPLE 65

The timer assembly of Example 64, wherein the proximity switch is a magnetic switch.

### EXAMPLE 66

The timer assembly of Example 64 or 65, wherein the proximity switch is a reed switch.

### EXAMPLE 67

The timer assembly of any one of Examples 63 to 66, wherein the base comprises a first magnet and wherein movement of the timer unit to the second position substantially aligns the switch with the first magnet to activate the switch.

### EXAMPLE 68

The timer assembly of any one of Examples 55 to 66, wherein the base comprises a first magnet and the timer unit comprises at least one second magnet and wherein the timer unit is releasably held at the second position by attraction between the first and second magnets.

### EXAMPLE 69

The timer assembly of Example 67, wherein the timer unit comprises at least one second magnet and the timer unit is releasably held at the second position by attraction between the first and second magnets.

### EXAMPLE 70

The timer assembly of Example 68 or 69, wherein the base comprises a third magnet and the timer unit is releasably held at the first position by attraction between the second and third magnets.

### EXAMPLE 71

The timer assembly of any one of Examples 55 to 70, wherein the timer unit is releasably mounted to the base.

### EXAMPLE 72

The timer assembly of Example 71, wherein the timer unit is movable to a third position relative to the base to allow removal of the timer unit from the base.

### EXAMPLE 73

The timer assembly of any one of Examples 55 to 72, whereing the timer unit comprises a power source.

### EXAMPLE 74

The timer assembly of any one of Examples 55 to 73, wherein the base does not comprise any electronic circuitry for monitoring the predetermined time period and/or for providing an alert signal.

### EXAMPLE 75

The timer assembly of any one of Examples 55 to 74, wherein the base comprises no electronic components.

### EXAMPLE 76

The assembly of any one of Examples 55 to 75, wherein the signalling apparatus is configured to provide one or more alert signals before expiry of the predetermined time period.

### EXAMPLE 77

The timer assembly of Example 76, wherein the signalling apparatus is configured to provide alert signals that are different before and after expiry of the predetermined time period.

### EXAMPLE 78

The label assembly of Example 77, wherein the different types of alert signals are light signals of different colours or different combinations of colours.

### EXAMPLE 79

The label assembly of any one of Examples 55 to 78, wherein the signal apparatus comprises at least one LED to provide the alert signal.

### EXAMPLE 80

A timer unit comprising:
an electronic timer to monitor a predetermined time period; and
a signalling apparatus that provides an alert signal on expiry of the predetermined time period;
wherein the timer unit is configured to be moved relative to a base between at least a first position of contact with the base and a second position of contact with the base, wherein movement of the timer unit to the second position initiates monitoring of the predetermined time period by the electronic timer.

### EXAMPLE 81

A timer assembly kit comprising:
a base; and
a plurality of timer units, each timer unit comprising:
   an electronic timer to monitor a predetermined time period; and
   a signalling apparatus that provides an alert signal on expiry of the predetermined time period;
wherein each timer unit is selectively usable with the base and movable relative to the base between at least a first position of contact with the base and a second position of contact with the base, wherein movement of the tinier unit to the second position initiates monitoring of the predetermined time period by the electronic timer.

### EXAMPLE 82

The timer assembly kit of Example 81, wherein the electronic timers of the plurality of timer units are configured to monitor different predetermined time periods.

### EXAMPLE 83

A label assembly comprising:
a timer to monitor a time period and a signalling apparatus that provides an alert signal on expiry of the time period;
a mounting mechanism for mounting the label assembly to an article, the mounting mechanism comprising an elongate portion and a locking portion;
a first face of the label assembly;
a second face of the label assembly; and
a through-hole extending between the first and second faces and comprising the locking portion;
wherein the locking portion is configured to receive the elongate portion to form a closed loop for mounting the label assembly to an article.

### EXAMPLE 84

The label assembly of Example 83, comprising a label body.

### EXAMPLE 85

The label assembly of Example 84, wherein the label body at least partially houses the timer and/or the signalling apparatus.

### EXAMPLE 86

The label assembly of Example 84 or 85, wherein the first and second faces are first and second faces of the label body.

### EXAMPLE 87

The label assembly of any one of Examples 83 to 86, wherein the elongate portion has a first end, a second end, and a central region between the first and second ends.

### EXAMPLE 88

The label assembly of Example 84, wherein the elongate portion has a first end, a second end, and a central region between the first and second ends, the second end being fixed to the label body.

### EXAMPLE 89

The label assembly of Example 87 or 88, wherein the first end and/or central region of the elongate portion is locked to the locking portion to form the closed loop.

### EXAMPLE 90

The label assembly of any one of Examples 83 to 89, wherein the elongate portion comprises one or more first teeth and the locking portion comprises a pawl and/or one or more second teeth adapted to lockingly engage the first teeth to form the closed loop.

### EXAMPLE 91

The label assembly of any one of Examples 83 to 90, wherein the mounting mechanism is configured for single use.

### EXAMPLE 92

The label assembly of any one of Examples 83 to 91, wherein the timer comprises at least one actuator to initiate monitoring of the predetermined time period.

### EXAMPLE 93

The label assembly of Example 92, wherein the at least one actuator comprises at least one tab that is released to initiate the monitoring of the predetermined time period.

### EXAMPLE 94

The label assembly of Example 92 or 93, further comprising a seal configured to seal an opening created upon release of the actuator.

### EXAMPLE 95

The label assembly of any one of Examples 83 to 94, wherein the signalling apparatus is configured to provide a light signal.

### EXAMPLE 96

The label assembly of Example 95, wherein the signalling apparatus is configured to provide light signals of different colours.

### EXAMPLE 97

The label assembly of Example 95 or 96, wherein the signalling apparatus is configured to provide different alert signals for different portions of time in the lead up to expiry of the predetermined time period.

### EXAMPLE 98

The label assembly of any one of Examples 83 to 97, wherein the label assembly is configured to monitor a predetermined time period associated with a medical device.

### EXAMPLE 99

The label assembly of any one of Examples 83 to 98, wherein the label assembly includes printed and/or written details relating to the time period.

### EXAMPLE 100

A label comprising:
a first label portion, a second label portion and a third label portion, the third label portion being connected to, and located between, the first and second label portions;
wherein the third label portion comprises a timer to monitor a predetermined time period and a signalling apparatus that provides an alert signal on expiry of the predetermined time period; and
wherein the first and second fixing portions are configured to be fixed together so that the label forms a closed loop.

### EXAMPLE 101

The label of Example 100, wherein the first and second label portions are configured to be permanently fixed together so that release of the closed loop cannot be performed without permanently damaging the label.

### EXAMPLE 102

The label of Example 100 or 101, wherein one or both of the first and second label portions comprises a fixing element to fix the first and second label portions together.

### EXAMPLE 103

The label of Example 102, wherein the fixing element is an adhesive layer.

### EXAMPLE 104

The label of any one of Examples 100 to 103, wherein the third label portion is releasably connected to one or both of the first label portion and the second label portion.

### EXAMPLE 105

The label of Example 104, wherein the releasable connection between the third label portion and the first and/r second label portions comprises a frangible element, tear line, tear notch, perforations and/or other region of weakness that enables manual separation of the label portions.

### EXAMPLE 106

The label of Example 104 or 105, wherein the releasable connection between the third label portion and the first and/or second label portions allows the closed loop to be opened without requiring release of the first portion from the second portion.

### EXAMPLE 107

The label of any one of Examples 100 to 106, wherein the label is formed in part from a one-piece sheet of material that extends across the first, second and third label portions.

### EXAMPLE 108

The label of any one of Examples 100 to 107, wherein the label is a wristband or is configured to be used as a wristband.

### EXAMPLE 109

A label comprising:
a timer to monitor a predetermined time period and a signalling apparatus that provides an alert signal on expiry of the time period;
a fixing portion to fix the label to a support; and
wherein at least part of the fixing portion is a transparent or translucent such that the support is at least partially visible through the fixing portion.

### EXAMPLE 110

The label of Example 109, wherein the label is configured to be fixed to the support by the fixing portion extending on or at least partially around the support.

### EXAMPLE 111

The label of Example 110, wherein the fixing portion is configured to extend around the support and fix to a surface of the support, fix to itself and/or fix to another surface of the label.

### EXAMPLE 112

The label of example 109, 110, or 111, wherein the fixing portion comprises an adhesive layer.

### EXAMPLE 113

The label of Example 112, wherein the adhesive layer is at least partially transparent.

### EXAMPLE 114

The label of Example 112 or 113, wherein the fixing portion comprises a base layer, the adhesive layer being located on the base layer, wherein the base layer is at least partially transparent.

### EXAMPLE 115

The label of any one of Examples 109 to 114 wherein the label has a first label portion comprising the timer and signalling apparatus, and a second label portion providing the fixing portion, and a frangible element, tear line, tear notch, perforations and/or other region of weakness between the first label portion and the second label portion that enables manual separation of the first label portion from the second label portion.

### EXAMPLE 116

A wristband comprising:
a first wristband portion, a second wristband portion and a third wristband portion, the third wristband portion being connected to, and located between, the first and second wristband portions;
wherein the third wristband portion comprises a timer to monitor a predetermined time period and a signalling apparatus that provides an alert signal on expiry of the predetermined time period; and
wherein the first and second wristband portions are configured to be fixed together so that the wristband forms a closed loop;
wherein the wristband is formed in part from a one-piece sheet of material that extends across the first, second and third wristband portions;
wherein the third wristband portion is releasably connected to one or both of the first wristband portion and the second wristband portion, the releasable connection between the third wristband portion and the first and/or second wristband portions comprising a frangible element, tear line, tear notch, or perforations.

### EXAMPLE 117

The wristband of Example 116, wherein the first and second wristband portions are configured to be permanently fixed together so that release of the closed loop cannot be performed without permanently damaging the wristband.

### EXAMPLE 118

The wristband of Example 116 or 117, wherein one or both of the first and second wristband portions comprises a fixing element to fix the first and second wristband portions together.

### EXAMPLE 119

The wristband of Example 118, wherein the fixing element is an adhesive layer.

### EXAMPLE 120

A label comprising:
a housing comprising opposing front and rear surfaces, and a plurality of sides surfaces that extend between the front and rear surfaces and define a peripheral edge of the housing;
a timer to monitor a predetermined time period and a signalling apparatus that provides an alert signal on expiry of the time period, the timer and signalling apparatus being at least partially located in the housing;
and one or more fixing elements for fixing the housing to a support surface,
wherein the housing comprises a groove extending at least partially along the peripheral edge of the housing.

### EXAMPLE 121

The label of Example 120, wherein the groove provides a finger grip for the label.

### EXAMPLE 122

The label of Example 120 or 121, comprising at least one tab that is released to initiate the monitoring of the predetermined time period.

### EXAMPLE 123

The label of Example 120, 121 or 122, wherein the tab extends through a slot in the housing, and wherein the slot is located in the groove of the housing.

### EXAMPLE 124

The label of any one of Examples 120 to 123, wherein the groove extends around the entire peripheral edge of the housing.

### EXAMPLE 125

The label of any one of Examples 120 to 124 wherein the fixing portion comprises an adhesive layer on a rear surface of the housing.

### EXAMPLE 126

The label of any one of Examples 120 to 125, wherein the fixing portion comprises one or more magnets.

### EXAMPLE 127

The label of Example 126, wherein the one or more magnets are configured for selectively fixing a front or rear surface of the housing to a support surface.

1. A label comprising:
a first label portion, a second label portion and a third label portion, the third label portion being connected to, and located between, the first and second label portions;
wherein the third label portion comprises a timer to monitor a predetermined time period and a signalling apparatus that provides an alert signal on expiry of the predetermined time period; and
wherein the first and second fixing portions are configured to be fixed together so that the label forms a closed loop.

2. The label of claim 1, wherein the first and second label portions are configured to be permanently fixed together so that release of the closed loop cannot be performed without permanently damaging the label.

3. The label of claim 1, wherein one or both of the first and second label portions comprises a fixing element to fix the first and second label portions together.

4. The label of claim 3, wherein the fixing element is an adhesive layer.

5. The label of claim 1, wherein the third label portion is releasably connected to one or both of the first label portion and the second label portion.

6. The label of claim 5, wherein the releasable connection between the third label portion and the first and/or second label portions comprises a frangible element, tear line, tear notch, perforations and/or other region of weakness that enables manual separation of the label portions.

7. The label of claim 5, wherein the releasable connection between the third label portion and the first and/or second label portions allows the closed loop to be opened without requiring release of the first portion from the second portion.

8. The label of claim 1, wherein the label is formed in part from a one-piece sheet of material that extends across the first, second and third label portions.

9. The label of claim 1, wherein the label is a wristband or is configured to be used as a wristband.

10. A wristband comprising:
a first wristband portion, a second wristband portion and a third wristband portion, the third wristband portion being connected to, and located between, the first and second wristband portions;
wherein the third wristband portion comprises a timer to monitor a predetermined time period and a signalling apparatus that provides an alert signal on expiry of the predetermined time period; and
wherein the first and second wristband portions are configured to be fixed together so that the wristband forms a closed loop;
wherein the wristband is formed in part from a one-piece sheet of material that extends across the first, second and third wristband portions;
wherein the third wristband portion is releasably connected to one or both of the first wristband portion and the second wristband portion, the releasable connection between the third wristband portion and the first and/or second wristband portions comprising a frangible element, tear line, tear notch, or perforations.

11. The wristband of claim 10, wherein the first and second wristband portions are configured to be permanently fixed together so that release of the closed loop cannot be performed without permanently damaging the wristband.

12. The wristband of claim 10, wherein one or both of the first and second wristband portions comprises a fixing element to fix the first and second wristband portions together.

13. The wristband of claim 12, wherein the fixing element is an adhesive layer.
